SEQUENCE LISTING (166 sequences)

SEQ ID NO: 1 - protein, 30 aa, synthetic construct
  REGION 1..30: note = Synthetic Peptite
VGECVRGRCPSGMCCSQFGYCGKGPKYCGR

SEQ ID NO: 2 - protein, 30 aa, synthetic construct
  REGION 1..30: note = Synthetic Peptide
GECNMYGRCPAGYCCSKYGYCGLGPAYCGD

SEQ ID NO: 3 - protein, 30 aa, synthetic construct
  REGION 1..30: note = Synthetic Peptide
IGECQKHKKCPKGMCCSYAGYCGTGSAYCG

SEQ ID NO: 4 - protein, 30 aa, synthetic construct
  REGION 1..30: note = Synthetic Peptide
PAVAQNCNCPAGMCCSQWGYCGTGPDYCGA

SEQ ID NO: 5 - protein, 30 aa, synthetic construct
  REGION 1..30: note = Synthetic Peptide
QQGACNNGHCPAGLCCSRFNFCGSGPAYCG

SEQ ID NO: 6 - protein, 30 aa, synthetic construct
  REGION 1..30: note = Synthetic Peptide
AEQCGRQSGKRKCPNKLCCSKFGWCGTSCD

SEQ ID NO: 7 - protein, 30 aa, synthetic construct
  REGION 1..30: note = Synthetic Peptide
AVAQSCGCPAHLCCSQWGFCSTGPDYCGAG

SEQ ID NO: 8 - protein, 30 aa, synthetic construct
  REGION 1..30: note = Synthetic Peptide
CGKAAGGKVCTNNYCCSKWGSCGIGPGYCG

SEQ ID NO: 9 - protein, 30 aa, synthetic construct
  REGION 1..30: note = Synthetic Peptide
GACGPNRSCRPGLCCSRFNYCGSGPAYCGR

SEQ ID NO: 10 - protein, 30 aa, synthetic construct
  REGION 1..30: note = Synthetic Peptide
AAAQNCGCQDGYCCSQWGYCGTTEAYCGQG

SEQ ID NO: 11 - protein, 30 aa, synthetic construct
  REGION 1..30: note = Synthetic Peptide
KQGHGLKCLDGMCCSIWGWCGNTQEYCAPG

SEQ ID NO: 12 - protein, 30 aa, synthetic construct
  REGION 1..30: note = Synthetic Peptide
ASGALCANGLCCSQYGYCGTTPAYCGPGCQ

SEQ ID NO: 13 - protein, 30 aa, synthetic construct
  REGION 1..30: note = Synthetic Peptide
QQCGSQAGGALCANGLCCSEYGYCGTTTAY

SEQ ID NO: 14 - protein, 30 aa, synthetic construct
  REGION 1..30: note = Synthetic Peptide
QQCGSQAGGALCANGLCCSQYGYCGTTTAY

SEQ ID NO: 15 - protein, 30 aa, synthetic construct
  REGION 1..30: note = Synthetic Peptide
CRAGVKECPEDECCSIWGWCGVTERYCGHD

SEQ ID NO: 16 - protein, 28 aa, synthetic construct
  REGION 1..28: note = Synthetic Peptide
GECVRGRCPGGLCCSKFGFCGSGPAYCG

SEQ ID NO: 17 - protein, 38 aa, synthetic construct
  REGION 1..38: note = Synthetic Peptide
SAAGPAVAQNCNCPAGMCCSQWGYCGTGPDYCGAGCQS

SEQ ID NO: 18 - protein, 38 aa, synthetic construct; identical to SEQ ID NO: 17
  REGION 1..38: note = Synthetic Peptide

SEQ ID NO: 19 - protein, 35 aa, synthetic construct
  REGION 1..35: note = Synthetic Peptide
VGPGGECGGRFGGCAGGQCCSRFGFCGSGPKYCAH

SEQ ID NO: 20 - protein, 35 aa, synthetic construct
  REGION 1..35: note = Synthetic Peptide
SGPNGQCGPGWGGCRGGLCCSQYGYCGSGPKYCAH

SEQ ID NO: 21 - protein, 30 aa, synthetic construct
  REGION 1..30: note = Synthetic Peptide
AAGQCYRGRCSGGLCCSKYGYCGSGPAYCG

SEQ ID NO: 22 - protein, 37 aa, synthetic construct
  REGION 1..37: note = Synthetic Peptide
MGQQGACGPSRSCRPGLCCSRFNYCGSGPAYCGRATP

SEQ ID NO: 23 - protein, 39 aa, synthetic construct
  REGION 1..39: note = Synthetic Peptide
TSIASGECNMYGRCPAGYCCSKYGYCGLGPAYCGDAEQQ

SEQ ID NO: 24 - protein, 38 aa, synthetic construct
  REGION 1..38: note = Synthetic Peptide
SMAQQGACNNGHCPAGLCCSRFNFCGSGPAYCGGAEEQ

SEQ ID NO: 25 - protein, 38 aa, synthetic construct
  REGION 1..38: note = Synthetic Peptide
SMGQQGACGPNRSCRPGLCCSRFNYCGSGPAYCGRATA

SEQ ID NO: 26 - protein, 42 aa, synthetic construct
  REGION 1..42: note = Synthetic Peptide
MAFQCGRQAGGARCPGGLCCSQYGYCGTTSQYCGRGQCQGQC

SEQ ID NO: 27 - protein, 35 aa, synthetic construct
  REGION 1..35: note = Synthetic Peptide
APGACGEQAGGKECPSGLCCAQWGFCGSGPEYCGV

SEQ ID NO: 28 - protein, 30 aa, synthetic construct
  REGION 1..30: note = Synthetic Peptide
VQDWCGNDCSAKECCKRDGYCGWGVDYCGG

SEQ ID NO: 29 - protein, 31 aa, synthetic construct
  REGION 1..31: note = Synthetic Peptide
KRCGSQAGCPNGHCCSQYGFCGFGPEYCGRG

SEQ ID NO: 30 - protein, 53 aa, synthetic construct
  REGION 1..53: note = Synthetic Peptide
VLYTGQCFKKDNICKYKVNGKQNIAKCPSAANKRCEKDKNKCTFDSYDRKVTC

SEQ ID NO: 31 - protein, 51 aa, synthetic construct
  REGION 1..51: note = Synthetic Peptide
ATYNGKCYKKDNICKYKAQSGKTAICKCYVKKCPRDGAKCEFDSYKGKCYC

SEQ ID NO: 32 - protein, 58 aa, synthetic construct
  REGION 1..58: note = Synthetic Peptide
LSKYGGECSKEHNTCTYRKDGKDHIVKCPSADNKKCKTDRHHCEYDDHHKTVDCQTPV

SEQ ID NO: 33 - protein, 58 aa, synthetic construct
  REGION 1..58: note = Synthetic Peptide
MDGYIKRRDGCKVACLIGNEGCDKECKAYGGSYGYCWTWGLACWCEGLPDDKTWKSET

SEQ ID NO: 34 - protein, 64 aa, synthetic construct
  REGION 1..64: note = Synthetic Peptide
DTCGAGYDPAQRRTNSPCQASNGDRHFCGCDRTGIVECKGGKWTEIQDCGRNSCHGGTEGGAKC

SEQ ID NO: 35 - protein, 64 aa, synthetic construct
  REGION 1..64: note = Synthetic Peptide
DTCGSGYNVDQRRTNSGCKAGNGDRHFCGCDRTGVVECKGGKWTEVQDCGSSSCKGTSNGGATC

SEQ ID NO: 36 - protein, 53 aa, synthetic construct
  REGION 1..53: note = Synthetic Peptide
VLYTGQCFKKDNICKYKVNGKQNIAKCPSAANKRCEKDKNKCTFDSYCRKVTC

SEQ ID NO: 37 - protein, 58 aa, synthetic construct
  REGION 1..58: note = Synthetic Peptide
LSKYGGECSKEHNTCTYRKCGKDHIVKCPSADNKKCKTDRHHCEYDDHHKTCDCQTPV

SEQ ID NO: 38 - protein, 58 aa, synthetic construct
  REGION 1..58: note = Synthetic Peptide
LEKYGGECSCECNTCTYRKDGKDHIVKCPSADNRKCKTDRHHCEYDDHHKTVDCQTPV

SEQ ID NO: 39 - protein, 58 aa, synthetic construct
  REGION 1..58: note = Synthetic Peptide
LSKYGGECSKTHNTCTYRKDGYDHIVKCPSADNKCCKTDRHHCEYDDHHATVDCQTPV

SEQ ID NO: 40 - protein, 58 aa, synthetic construct
  REGION 1..58: note = Synthetic Peptide
LSKYGGECSKEHNTCTYRKDGKDHQCKCHSRDNKKCKTDRHHCEYDDHHKTVDCQTPV

SEQ ID NO: 41 - protein, 58 aa, synthetic construct
  REGION 1..58: note = Synthetic Peptide
LSCYGGECAKEHNTCTYRKDGLDHIVKCPSADNKKCKTCRHHCEYDDHHKTVDCQTPV

SEQ ID NO: 42 - protein, 58 aa, synthetic construct
  REGION 1..58: note = Synthetic Peptide
LSCYGGNCSCEHNTCTYRKDGKDHICKCPSADNKKCKTDRHHCEYDDHHKTVDCQTPV

SEQ ID NO: 43 - protein, 58 aa, synthetic construct
  REGION 1..58: note = Synthetic Peptide
LSKYGGECSKEHNTCTYRKDGKDHCVKCPSADNKKCKTDRHHCEYDDHHTTVDCQRPR

SEQ ID NO: 44 - protein, 58 aa, synthetic construct
  REGION 1..58: note = Synthetic Peptide
LSKYGGECCKEHNTCTYFKDGKDHIVKCPSADNKQCKTDRHHCEYDDHHKTVCCQTPV

SEQ ID NO: 45 - protein, 58 aa, synthetic construct
  REGION 1..58: note = Synthetic Peptide
LSKYGGECCKEHNTCTYRKDGKDHIVKCPSADNKKCLTDRHHCEYDDHHCKVDCQTPV

SEQ ID NO: 46 - protein, 58 aa, synthetic construct
  REGION 1..58: note = Synthetic Peptide
LAKYGGECKKEHNTCTYCKDGKDHIVKCPSPDNKKCKTDRHHCEYDDHHKTVDCQTPV

SEQ ID NO: 47 - protein, 58 aa, synthetic construct
  REGION 1..58: note = Synthetic Peptide
LSKYGGECSKEHNTCTARKDGKDHIVKCPSADCKKCKTDRHHCYYDEHHKTVDCQTPV

SEQ ID NO: 48 - protein, 58 aa, synthetic construct
  REGION 1..58: note = Synthetic Peptide
LSKYGGECSTEHNTCAYRKDGKDHIVKCPSADNKKCKTDRHHCEYDDHHKTVCCQTPC

SEQ ID NO: 49 - protein, 58 aa, synthetic construct
  REGION 1..58: note = Synthetic Peptide
LSKYGGECSKEHNTCTYRKDMKDHAVKCPSADNKKCKTDRHCCEYDKHHKTVDCQTPV

SEQ ID NO: 50 - protein, 58 aa, synthetic construct
  REGION 1..58: note = Synthetic Peptide
LSKYGIECSKEHNTCTYRKDGKDHIVKCESADNKKCKWDRHHCEYDCHHKTVDCQTPV

SEQ ID NO: 51 - protein, 58 aa, synthetic construct
  REGION 1..58: note = Synthetic Peptide
LSKRGGECSKEHNTCTYRKDGKDHIVKCPSADNKKCKCDRHHCECDDHHKTVDCQGPV

SEQ ID NO: 52 - protein, 58 aa, synthetic construct
  REGION 1..58: note = Synthetic Peptide
LSKYGAECDKEHGTCTYRKDGKDHICKCPSADNKKCKTDRHHCEYDDHHKTVDCQTPV

SEQ ID NO: 53 - protein, 58 aa, synthetic construct
  REGION 1..58: note = Synthetic Peptide
LSCYGGECSKEHNYCTYRKDGKDHIVKCPSADNKKCKTDNPHCEYDDHHKTVDCQTPV

SEQ ID NO: 54 - protein, 58 aa, synthetic construct
  REGION 1..58: note = Synthetic Peptide
LSKGGGECSKEHNTCTYRKDGKDHDVKCPSADNKKCKTDRHHCEYDDHFKCVDCQTPV

SEQ ID NO: 55 - protein, 58 aa, synthetic construct
  REGION 1..58: note = Synthetic Peptide
LAKYGGECSKEHNTCYYRKDGCDHIVKCPSADNKKCKTDRHHCEYDDHHKTVECQTPV

SEQ ID NO: 56 - protein, 58 aa, synthetic construct
  REGION 1..58: note = Synthetic Peptide
LSKYGGECSKEHNTCCYFKDGKDHIVKCPSADNKKCYTDRHHCEYCDHHKTVDCQTPV

SEQ ID NO: 57 - protein, 58 aa, synthetic construct
  REGION 1..58: note = Synthetic Peptide
LSKYGGECSKEHNTCTYRWDGADHIVTCPSADNKKCKTDRHHCEYDDHHKTVDCLTPV

SEQ ID NO: 58 - protein, 58 aa, synthetic construct
  REGION 1..58: note = Synthetic Peptide
LSKYGGECSKEHNTCTYRKDGKDHIVKCPSADEKKCKTDRHCCEACDHHKTVDCQTPV

SEQ ID NO: 59 - protein, 58 aa, synthetic construct
  REGION 1..58: note = Synthetic Peptide
LQKYGGNCSKEHNTCTYRKDGKDHIVKCPSADNKKCKTDRHHCEYDDHHKAVDCCTPV

SEQ ID NO: 60 - protein, 58 aa, synthetic construct
  REGION 1..58: note = Synthetic Peptide
LSKYGGECSKEHNTCCYRKDGKAHEVKCPSAFNKKCKTDRHHCEYDDHHKTVDCQTPV

SEQ ID NO: 61 - protein, 58 aa, synthetic construct
  REGION 1..58: note = Synthetic Peptide
LSKYGGECSAPHNTCTYRKDGCDHIVKCPSADNKKCKTDRHHCEYNDHHKTVDCQTPV

SEQ ID NO: 62 - protein, 58 aa, synthetic construct
  REGION 1..58: note = Synthetic Peptide
LSKYGGECSKHHNTCTYRKDGKDHWVKCPSADNKKCKTDRHHCEYADHHKTVDCQTCV

SEQ ID NO: 63 - protein, 58 aa, synthetic construct
  REGION 1..58: note = Synthetic Peptide
LSKYGGECWKEHNTCTEQKDGKDHIVKCPSADNKKCKTDLHHCEYDDHHKTVDCQTPV

SEQ ID NO: 64 - protein, 58 aa, synthetic construct
  REGION 1..58: note = Synthetic Peptide
LSKCGGECSKEHNVCTYRKDGKDHIVKCCSADNKKCKADRHHCEYDDHHKTVDCQTPV

SEQ ID NO: 65 - protein, 58 aa, synthetic construct
  REGION 1..58: note = Synthetic Peptide
LSKYGGECSKEHNTCTYRKDGKDHIVKCPSADNKSCKIDCHHCEYDDHHKTVDCQAPV

SEQ ID NO: 66 - protein, 58 aa, synthetic construct
  REGION 1..58: note = Synthetic Peptide
LSKYGGECSKEMNTCTYRKDGKAHIVKCPSADNKKCKTDRHVCCYDDHHKTVDCQTPV

SEQ ID NO: 67 - protein, 58 aa, synthetic construct
  REGION 1..58: note = Synthetic Peptide
LSKYGDECSKEHNTCTYVKDGKDHIVKCPSADNKKCKTDRHHCECDDHHKAVDCQTPV

SEQ ID NO: 68 - protein, 58 aa, synthetic construct
  REGION 1..58: note = Synthetic Peptide
LSKYGWECSKEHNTCTFRCDCKDHIVKCPSADNKKCKTDRHHCEYDDHHKTVDCQTPV

SEQ ID NO: 69 - protein, 58 aa, synthetic construct
  REGION 1..58: note = Synthetic Peptide
LSKYGGECSKEANTCTYRADGKDHIVKCPSADNKKCKCDRHHCEYDDHHKTVDCQTPA

SEQ ID NO: 70 - protein, 58 aa, synthetic construct
  REGION 1..58: note = Synthetic Peptide
LSKEGGECSKEHNTCTYRKDGKDHIVKCPSADNKKCCRDRFHCEYDDHHKTVDCQTPV

SEQ ID NO: 71 - protein, 58 aa, synthetic construct
  REGION 1..58: note = Synthetic Peptide
LSKYHGECSKEHNTCTYRKDGKDHIVCCPSADNKKCKTQRHHCEYDDHHATVDCQTPV

SEQ ID NO: 72 - protein, 58 aa, synthetic construct
  REGION 1..58: note = Synthetic Peptide
LSKYGGECSKEHNTCTYRADGKDHIVKCPSADNKKCKTCRHHCEYDDHHKAVDCQTGV

SEQ ID NO: 73 - protein, 58 aa, synthetic construct
  REGION 1..58: note = Synthetic Peptide
LSKYGGCCSKEHNTCTERKDGKDHIVKCPSADNKKCKTDRHHCEYDDHHKTVDCQSPA

SEQ ID NO: 74 - protein, 58 aa, synthetic construct
  REGION 1..58: note = Synthetic Peptide
LSKYGGACSKEHNTCTYRKDGKDCIVKCPSADNKKCKWDRHHCEYDDNHKTVDCQTPV

SEQ ID NO: 75 - protein, 58 aa, synthetic construct
  REGION 1..58: note = Synthetic Peptide
LSKGGGECSKEHNTCTYRKDGKDHIVKCRSADNKACKTDRQHCEYDDHHKTVDCQTPV

SEQ ID NO: 76 - protein, 58 aa, synthetic construct
  REGION 1..58: note = Synthetic Peptide
LSKAGGECSKFHNTCTYRKDGDDHICKCPSADNKKCKTDRHHCEYDDHHKTVDCQTPV

SEQ ID NO: 77 - protein, 58 aa, synthetic construct
  REGION 1..58: note = Synthetic Peptide
LWKYGGECSKEHNKCTNRKDGKDHIVKCPSADNKKCKTDRHHCEYDDHFKTVDCQTPV

SEQ ID NO: 78 - protein, 58 aa, synthetic construct
  REGION 1..58: note = Synthetic Peptide
LSFYGGECSKEHNTCTYRKDGKDHIVKCPSADNKKCKIDRAHCEYDDHHCTVDCQTPV

SEQ ID NO: 79 - protein, 58 aa, synthetic construct
  REGION 1..58: note = Synthetic Peptide
LSCHGAECSKEHNTCTYRKDGKDHIVKCPSADNKKCKTDRHHCDYDDHHKTVDCQTPV

SEQ ID NO: 80 - protein, 58 aa, synthetic construct
  REGION 1..58: note = Synthetic Peptide
LSKYGGECQKEHNTCTYRKDAKDHCVKCPEADNKKCKTDRHHCEYDDHHKTVDCQTPV

SEQ ID NO: 81 - protein, 58 aa, synthetic construct
  REGION 1..58: note = Synthetic Peptide
LSKYGGECSKEDNTCTYRKDGKDHIVKCPSADNKKCCTDRHHCEYDDHHKTVDCQKPN

SEQ ID NO: 82 - protein, 58 aa, synthetic construct
  REGION 1..58: note = Synthetic Peptide
LSKYGGECSKEMGTCTYACDGKDHIVKCPSADNKKCKTDRHHCEYDDHHKTVDCQTPV

SEQ ID NO: 83 - protein, 58 aa, synthetic construct
  REGION 1..58: note = Synthetic Peptide
LVKYGGECSKEHWTCTYRKDGKCHIVKCPSADNKKCKTDRHHCEYDDAHKTVDCQTPV

SEQ ID NO: 84 - protein, 58 aa, synthetic construct
  REGION 1..58: note = Synthetic Peptide
LQKYGGECSKEHNTCWYRKDGKDHIVKCCSADNKKCKTDRHHCEYDRHHKTVDCQTPV

SEQ ID NO: 85 - protein, 58 aa, synthetic construct
  REGION 1..58: note = Synthetic Peptide
LSKYGGECSKEHNTCCYRKDGKDHIVCCPSRDSKKCKTDRHHCEYDDHHKTVDCQTPV

SEQ ID NO: 86 - protein, 58 aa, synthetic construct
  REGION 1..58: note = Synthetic Peptide
LSKYGGECSKECNTCTYRKDGKDHIVKCPSADNKNCKTDRRHCEYDDHHSTVDCQTPV

SEQ ID NO: 87 - protein, 58 aa, synthetic construct
  REGION 1..58: note = Synthetic Peptide
LSKYGGECSCEHNTCTYRKDGKDHIVKCPSADAKKCKTDRHHCEYDDGHKTVDCQTPA

SEQ ID NO: 88 - protein, 58 aa, synthetic construct
  REGION 1..58: note = Synthetic Peptide
CSKYGGECCKEHNTCTYRKDGFDHISKCPSADNKKCKTDRHHCEYDDHHKTVDCQTPV

SEQ ID NO: 89 - protein, 58 aa, synthetic construct
  REGION 1..58: note = Synthetic Peptide
LSKYGGECSKAHGTCTYRKDGKDDIVCCPSADNKKCKTDRHHCEYDDHHKTVDCQTPV

SEQ ID NO: 90 - protein, 58 aa, synthetic construct
  REGION 1..58: note = Synthetic Peptide
LSKYGGECSKEHNTCTYRKDGKDHIVKCPSQDNKKCKTDRHHCCYDDHHKTVDCQEPD

SEQ ID NO: 91 - protein, 58 aa, synthetic construct
  REGION 1..58: note = Synthetic Peptide
LSKYGGECSKEHNTCTYRKDGKDHIVKCPAADNKKCKTDCHHCEYTDHHKTVDCQTEV

SEQ ID NO: 92 - protein, 58 aa, synthetic construct
  REGION 1..58: note = Synthetic Peptide
LGAYGGECSKEHNTCTYRKDGKDHIVKCPSCDNKKCKTDRHHCEYDDHGKTVDCQTPV

SEQ ID NO: 93 - protein, 58 aa, synthetic construct
  REGION 1..58: note = Synthetic Peptide
LSKYHGECAKEHNTCVYRKDGKDHIVKCPSADNKKCKTDRHHCEYDDHHKTVDCVTPV

SEQ ID NO: 94 - protein, 58 aa, synthetic construct
  REGION 1..58: note = Synthetic Peptide
LSKYGGECSKAHNTCTYRKDGRDHIVKCPSADNKKCKTDRHHCEYDDHHKCVDCKTPV

SEQ ID NO: 95 - protein, 58 aa, synthetic construct
  REGION 1..58: note = Synthetic Peptide
LSKYGGECSKEHNTCTYRKDVKDHIVKCASADNDKCKTDRHHCCYDDHHKTVDCQTPV

SEQ ID NO: 96 - protein, 58 aa, synthetic construct
  REGION 1..58: note = Synthetic Peptide
LNKYGGECSKEHVTCTYRKDGKDAIVKCPSADNKKCKTCRHHCEYDDHHKTVDCQTPV

SEQ ID NO: 97 - protein, 58 aa, synthetic construct
  REGION 1..58: note = Synthetic Peptide
LSKYGGECSKEHNNCTYRKDGVDHIVKCPSWDNCKCKTDRHHCEYDDHHKTVDCQTPV

SEQ ID NO: 98 - protein, 58 aa, synthetic construct
  REGION 1..58: note = Synthetic Peptide
LSKYGGECAKEHNTCTYRKDGKDCIVKCPSADNKKCKTDRHHCEYDDHHKHVICQTPV

SEQ ID NO: 99 - protein, 58 aa, synthetic construct
  REGION 1..58: note = Synthetic Peptide
LSKYGGECSKEHNDCTYRKDGKDHIVMCPSADNKKCKTDRHHCEYDDHCKAVDCQTPV

SEQ ID NO: 100 - protein, 58 aa, synthetic construct
  REGION 1..58: note = Synthetic Peptide
LSKYGGECSKEHNTCTYRCDGKDHIVKCPSAVNKKCKTARHHCEYDAHHKTVDCQTPV

SEQ ID NO: 101 - protein, 58 aa, synthetic construct
  REGION 1..58: note = Synthetic Peptide
LSKYGGECSKEHNTCTYRKDGKDHICKCPSAANKKCKLDRHHCEYDDHHKTVDCGTPV

SEQ ID NO: 102 - protein, 58 aa, synthetic construct
  REGION 1..58: note = Synthetic Peptide
LSKYGGECGREHNTCTYRWDGKDHIVKCPSADNKKCKTDRHHCEYCDHHKTVDCQTPV

SEQ ID NO: 103 - protein, 58 aa, synthetic construct
  REGION 1..58: note = Synthetic Peptide
LSKYGYECSKWHNTCTYRKDGKDHIVKCPSVDNKKCKTDRHHCEYDDHHKTVDCQTFV

SEQ ID NO: 104 - protein, 58 aa, synthetic construct
  REGION 1..58: note = Synthetic Peptide
LSKYGGECSKEHNTCTYRKDGKDHIEKCPSADNKPCATDRHHCEYDDHHKCVDCQTPV

SEQ ID NO: 105 - protein, 58 aa, synthetic construct
  REGION 1..58: note = Synthetic Peptide
ASKYGGECSKEENTCTYRKDGKCHIVKCPSADNKKCKTDRHHCEYDRHHKTVDCQTPV

SEQ ID NO: 106 - protein, 58 aa, synthetic construct
  REGION 1..58: note = Synthetic Peptide
LSKYGGECSIEHNTCTYRKDGKDHIVKCPDRDNKKCKTDRHHCEYDDHHKTVDCQTCV

SEQ ID NO: 107 - protein, 58 aa, synthetic construct
  REGION 1..58: note = Synthetic Peptide
LSKYGGECSKEHNTCTYLKDGKDHIAKCPSAPCKKCKTDRHHCEYDDHHKTVDCQTPV

SEQ ID NO: 108 - protein, 58 aa, synthetic construct
  REGION 1..58: note = Synthetic Peptide
LSKYGGWCSKECNTCNYRKDGKDHNVKCPSADNKKCKTDRHHCEYDDHHKTVDCQTPV

SEQ ID NO: 109 - protein, 58 aa, synthetic construct
  REGION 1..58: note = Synthetic Peptide
LSKYGGECSKEHNTCTYRKDAKDHIVKCPSADNKKCKTDCHHCFYDDHHKAVDCQTPV

SEQ ID NO: 110 - protein, 58 aa, synthetic construct
  REGION 1..58: note = Synthetic Peptide
LSKQGGECSKEHNTCTYRKDGKDCIVKCPSAANKKCKTHRHHCEYDDHHKTVDCQTPV

SEQ ID NO: 111 - protein, 58 aa, synthetic construct
  REGION 1..58: note = Synthetic Peptide
LIKYGGECSYEHNTCTERKDGKDHIVKCPSADNKKCKTDRHACEYDDHHKTVDCQTPV

SEQ ID NO: 112 - protein, 58 aa, synthetic construct
  REGION 1..58: note = Synthetic Peptide
LSKYGGECHKEHNCCTYRKDGKDHIVKCPSCDQKKCKTDRHHCEYDDHHKTVDCQTPV

SEQ ID NO: 113 - protein, 58 aa, synthetic construct
  REGION 1..58: note = Synthetic Peptide
LSKYGGECRKEHNTCTYRKDGKDHIVKCPSADNKKCKGDRHHCEYDDLHKTVDCQTPC

SEQ ID NO: 114 - protein, 58 aa, synthetic construct
  REGION 1..58: note = Synthetic Peptide
LSKYGLECSKEHNTCTYRKDGKDHIVKCASADNKKCKTDRHHCEYDDHHKTVCCQTYV

SEQ ID NO: 115 - protein, 58 aa, synthetic construct
  REGION 1..58: note = Synthetic Peptide
LSKYGGECSKEHNTCTYRKDGKACIVKCPSADNKKCKTDRHHCEYDSHHKTVDCQTPF

SEQ ID NO: 116 - protein, 58 aa, synthetic construct
  REGION 1..58: note = Synthetic Peptide
LSKYGGECSKEHNCCPYRKDGKRHIVKCPSADNKKCKTRRHHCEYDDHHKTVDCQTPV

SEQ ID NO: 117 - protein, 58 aa, synthetic construct
  REGION 1..58: note = Synthetic Peptide
LSKYGGECSCEHNTCTYRKDGKDHNVKCPSTDNKKCKTDRHHCEYDDHHKTVGCQTPV

SEQ ID NO: 118 - protein, 58 aa, synthetic construct
  REGION 1..58: note = Synthetic Peptide
LSKYGGECSKEHNTCTYRKDGKDHICRCPAADNKKCKTDRHHCEYDDHHCTVDCQTPV

SEQ ID NO: 119 - protein, 58 aa, synthetic construct
  REGION 1..58: note = Synthetic Peptide
LSKYGGECSKEHNTCTYRKDCADHIVKCPTADNKKCKHDRHHCEYDDHHKTVDCQTPV

SEQ ID NO: 120 - protein, 58 aa, synthetic construct
  REGION 1..58: note = Synthetic Peptide
LSKYDGECSKEHNTCTYRKDGKSHIVKCPSADNKKCKTDRHHCEADDHHCTVDCQTPV

SEQ ID NO: 121 - protein, 58 aa, synthetic construct
  REGION 1..58: note = Synthetic Peptide
LSKGGGECSKQHNTCTYRKDGKDHIVKCPSADNKKCKFDRHHCEYDDHHKTVDCQTSV

SEQ ID NO: 122 - protein, 58 aa, synthetic construct
  REGION 1..58: note = Synthetic Peptide
LSKYGGECSKEANTCTYRKDGKDHICKCPSADNKKCKTFRHHCEYQDHHKTVDCQTPV

SEQ ID NO: 123 - protein, 58 aa, synthetic construct
  REGION 1..58: note = Synthetic Peptide
LSKYGGECSKEHCTCGDRKDGKDHIVKCPSADNKKCCTDRHHCEYDDHHKTVDCQTPV

SEQ ID NO: 124 - protein, 58 aa, synthetic construct
  REGION 1..58: note = Synthetic Peptide
LSKYGGECSKEHNTCTYRKDAHDHIVKCHSADNKKCKTDRHHCECDDHHKTVDCQTPV

SEQ ID NO: 125 - protein, 58 aa, synthetic construct
  REGION 1..58: note = Synthetic Peptide
LSKYGGECSKEHNTCTYRKDGKDHIVKCPSADNCKCKTARHHCEFDDHHKTVPCQTPV

SEQ ID NO: 126 - protein, 58 aa, synthetic construct
  REGION 1..58: note = Synthetic Peptide
LSRYGGECSKEHNTCTYRKDGCDHIVKCPSMDNKKCKTDRHHCEIDDHHKTVDCQTPV

SEQ ID NO: 127 - protein, 58 aa, synthetic construct
  REGION 1..58: note = Synthetic Peptide
LSKYGGECSKEHNTCTYRKDGKDCIVWCPSADNKKCKTDRHHCMYDDHHKTVDCQYPV

SEQ ID NO: 128 - protein, 58 aa, synthetic construct
  REGION 1..58: note = Synthetic Peptide
LSKYGGECSKHHNTCTYRKDGKDPIVKCPSADNKKCKTDHCHCEYDDHHKTVDCQTPV

SEQ ID NO: 129 - protein, 58 aa, synthetic construct
  REGION 1..58: note = Synthetic Peptide
LSKYGGNCSKEHNTCTARKDGKDHIVKCPSADNKKCKTDDHHCEYADHHKTVDCQTPV

SEQ ID NO: 130 - protein, 58 aa, synthetic construct
  REGION 1..58: note = Synthetic Peptide
CAKYGGCCSKEHNTCTYRKDGKDHIVKCPSADNKKCKTIRHHCEYDDHHKTVDCQTPV

SEQ ID NO: 131 - protein, 58 aa, synthetic construct
  REGION 1..58: note = Synthetic Peptide
LSKYGGECSKEHNTCTIRKDGKDHIVKCPSADNKKCKTDRHHCEYDCHHATVDCQTPI

SEQ ID NO: 132 - protein, 58 aa, synthetic construct
  REGION 1..58: note = Synthetic Peptide
LSKYGGECSKEHNTCTYRKDGKDHIVHCPSCDNKKCKTDRHHCEYDAHHKEVDCQTPV

SEQ ID NO: 133 - protein, 58 aa, synthetic construct
  REGION 1..58: note = Synthetic Peptide
LSTYGGECSKEHNTCTYRKDGKDHIVKCPSADNKKCKTDAHHCESDDHHKCVDCQTPV

SEQ ID NO: 134 - protein, 58 aa, synthetic construct
  REGION 1..58: note = Synthetic Peptide
LSKYGGECSKEHNACNYRKDGKDHIVKCPSADNKKCKTDCHHCEYDDTHKTVDCQTPV

SEQ ID NO: 135 - protein, 58 aa, synthetic construct
  REGION 1..58: note = Synthetic Peptide
LSKYGGECSYEHNTCTYRKDGKDVIVKCPSADWKKCKTDRHHCEYDDHHKTVDCQMPV

SEQ ID NO: 136 - protein, 58 aa, synthetic construct
  REGION 1..58: note = Synthetic Peptide
LSKYGGGCSKEHNTCTYRKDGKDHIVKCPSADNKACKCDRHHCEYDDHHKTVWCQTPV

SEQ ID NO: 137 - protein, 58 aa, synthetic construct
  REGION 1..58: note = Synthetic Peptide
LSKYGGACSKEHNTCTYRKDCKDHIVKCPSADNKKCKTDRHACELDDHHKTVDCQTPV

SEQ ID NO: 138 - protein, 58 aa, synthetic construct
  REGION 1..58: note = Synthetic Peptide
LSKYGCECSKEHNTCTYRKDGKDHAVKCPPADNKKCKTDRHHCEYKDHHKTVDCQTPV

SEQ ID NO: 139 - protein, 58 aa, synthetic construct
  REGION 1..58: note = Synthetic Peptide
LSKYGGECSKEHNTCTAWKDGKDHIVKCPSADNKKCKWDRHHCEYDDHHKTVDCQTCV

SEQ ID NO: 140 - protein, 58 aa, synthetic construct
  REGION 1..58: note = Synthetic Peptide
LSKYGGECSKEHNTCTYRKDGKDHIVKCPSCANKKCKTDRHHCEYDDDHKTVDCQCPV

SEQ ID NO: 141 - protein, 58 aa, synthetic construct
  REGION 1..58: note = Synthetic Peptide
ASKYGGECSDEHNTCTYRKDGKDHIVKCPSADKKCCKTDRHHCEYDDHHKTVDCQTPV

SEQ ID NO: 142 - protein, 58 aa, synthetic construct
  REGION 1..58: note = Synthetic Peptide
LSKYGGECSKRHNTCTYRKDGKDHIVGCPDADNKKCKTDRHHCEYDDHHKTVCCQTPV

SEQ ID NO: 143 - protein, 58 aa, synthetic construct
  REGION 1..58: note = Synthetic Peptide
LSCYGGECSKEHNTCTYRKDGKDHIVKCPSADNKKCKTDRHHCEYVDHAMTVDCQTPV

SEQ ID NO: 144 - protein, 58 aa, synthetic construct
  REGION 1..58: note = Synthetic Peptide
LSKYGCECSKEHNTCTYRKDGKDHIVKCPSADNKKCKGDRHHCEWDDHHKTVDCQTAV

SEQ ID NO: 145 - protein, 58 aa, synthetic construct
  REGION 1..58: note = Synthetic Peptide
ISKYGGECSKEHNTCTYRKDGKDCIVKCPSADNCKCKTDRHHCEYDDHAKTVDCQTPV

SEQ ID NO: 146 - protein, 58 aa, synthetic construct
  REGION 1..58: note = Synthetic Peptide
LSKYGGECSKEHNTCTYRNDGKDHIFKCPSADNKKCKTDRVHCEYDDCHKTVDCQTPV

SEQ ID NO: 147 - protein, 58 aa, synthetic construct
  REGION 1..58: note = Synthetic Peptide
LSKYGGECSKEHNTCTCRKDGKDHIVKCCSADNKKCKTDRHFCEYDDHHKTVDCQTAV

SEQ ID NO: 148 - protein, 58 aa, synthetic construct
  REGION 1..58: note = Synthetic Peptide
LSKYGGECSKIHNTCTYRKDGKDHITKCDSACNKKCKTDRHHCEYDDHHKTVDCQTPV

SEQ ID NO: 149 - protein, 58 aa, synthetic construct
  REGION 1..58: note = Synthetic Peptide
LSKYGGECSKEHNTCTYRKDGKVHIVKCASADNKKCKCDRHHCEYDDHHKTVDCTTPV

SEQ ID NO: 150 - protein, 58 aa, synthetic construct
  REGION 1..58: note = Synthetic Peptide
LSKYGGECSKEHNTCTYRKDGKDSNVKCPAADNKKCKTDRHHCECDDHHKTVDCQTPV

SEQ ID NO: 151 - protein, 58 aa, synthetic construct
  REGION 1..58: note = Synthetic Peptide
LSKYGGECSKEHNYCTYRKDGKDHIVKCPSADNKKCKTDRHHCEYDVHHKTVDCATPN

SEQ ID NO: 152 - protein, 58 aa, synthetic construct
  REGION 1..58: note = Synthetic Peptide
LSKYGGECSKEHNTCTYRKDGKDHIVKCPCADCKKCKTDRHHCEYDDSHKTVDCQEPV

SEQ ID NO: 153 - protein, 58 aa, synthetic construct
  REGION 1..58: note = Synthetic Peptide
LSKYGGECSKEWNTCTYRKDGKDHIVKCPSADNKKCKSDRHHCEYCDHHKTVCCQTPV

SEQ ID NO: 154 - protein, 58 aa, synthetic construct
  REGION 1..58: note = Synthetic Peptide
LSKYGGECSKEHNTCTYRQDGKDHIVKCPSCDNKKCKTDRHHCEADDHHKTVDCATPV

SEQ ID NO: 155 - protein, 58 aa, synthetic construct
  REGION 1..58: note = Synthetic Peptide
LSKYGGECSKEVNTCTYRKDGKDHIVKCPSACNKKCATDRHHCEYADHHKTVDCQTPV

SEQ ID NO: 156 - protein, 58 aa, synthetic construct
  REGION 1..58: note = Synthetic Peptide
LSKYEGECSKEHNTCTYRKDGKDHIVKCPSHDNKKCKTDRHHCERDDCHKTVDCQTPV

SEQ ID NO: 157 - protein, 58 aa, synthetic construct
  REGION 1..58: note = Synthetic Peptide
LSKYGGECSKEHNTCTYRKDGKDHIVKCPSARNKKCKTDRAHCEYCEHHKTVDCQTPV

SEQ ID NO: 158 - protein, 58 aa, synthetic construct
  REGION 1..58: note = Synthetic Peptide
LSKYGGECSKESNTCTYRKDGKDHIVKCPSADNKWCKTDRHHCYYRDHHKTVDCQTPV

SEQ ID NO: 159 - protein, 58 aa, synthetic construct
  REGION 1..58: note = Synthetic Peptide
LSKYGGMCSKEHNTCTYRKDGKDHIVKCPSADCKKCKTDYHHCEYDDHHKTVDCQTPR

SEQ ID NO: 160 - protein, 58 aa, synthetic construct
  REGION 1..58: note = Synthetic Peptide
LRKYGGECSKEHNTCTYRKDGKWHIVKCPSADNKKCKTHRHHCEYDDHHKCVDCQTPV

SEQ ID NO: 161 - protein, 58 aa, synthetic construct
  REGION 1..58: note = Synthetic Peptide
LSKYGGECSKAHNTCTYRKDGKDHIVKCPSAINKKCKTDRHHCEYPDHCKTVDCQTPV

SEQ ID NO: 162 - protein, 58 aa, synthetic construct
  REGION 1..58: note = Synthetic Peptide
LSKYGGECSPEHATCCYRKDGKDHIVKCPSADNKKCKTDRHHCEYDDHHKTVDCQNPV

SEQ ID NO: 163 - protein, 58 aa, synthetic construct
  REGION 1..58: note = Synthetic Peptide
LSKYGGECSKEHNTCTYRKDGKDHIVKCPSADNKKCKTPRCHCEYDDHHKTVACQAPV

SEQ ID NO: 164 - protein, 58 aa, synthetic construct
  REGION 1..58: note = Synthetic Peptide
ADKYGGECSKCHNTCTYRKDGKDHIVKCPSADNKKCKTDRHHCEYDDHHKTVDCQTQV

SEQ ID NO: 165 - protein, 64 aa, synthetic construct
  REGION 1..64: note = Synthetic Peptide
DTCGAGYDPAQRRTNSPCQASNGDRHFCGCDCTGIVECKGGKWTEIQDCGRNSCHGGTEGGAKC

SEQ ID NO: 166 - protein, 14 aa, synthetic construct
  REGION 1..14: note = Synthetic Peptide
  VARIANT 2: note = Xaa = any amino acid
  VARIANT 10: note = Xaa = F, W, or Y
  VARIANT 12: note = Xaa = F, W, or Y
  VARIANT 3: note = Xaa = any amino acid
  VARIANT 5: note = Xaa = any amino acid
  VARIANT 9: note = Xaa = any amino acid
CXXGXCCSXXGXCG

(19) United States
(12) Patent Application Publication
(10) Pub. No.: US 2024/0268395 A1
(43) Pub. Date: Aug. 15, 2024

(54) ANTIFUNGAL PROTEIN COMPOSITION

(71) Applicant: GEAENZYMES CO., Sunnyvale, CA (US)

(72) Inventors: Javier GIMPEL, Vina del Mar (CL); Ezequiel JURITZ, Santiago (CL); Pedro RETAMAL, Santiago (CL); Simon CORREA, Santiago (CL); Roberto IBANEZ, Santiago (CL); Romualdo PAZ, Santiago (CL); Leonardo ALVAREZ, Santiago (CL)

(21) Appl. No.: 18/639,139

(22) Filed: Apr. 18, 2024

Related U.S. Application Data
(63) Continuation of application No. 17/660,969, filed on Apr. 27, 2022.
Application No. 17/660,969 is a continuation of application No. PCT/US2020/059410, filed on Nov. 6, 2020.
(60) Provisional application No. 62/932,613, filed on Nov. 8, 2019.

(51) Int. Cl. A01N 63/50; A01N 37/46

(52) U.S. Cl. CPC A01N 63/50; A01N 37/46

(57) ABSTRACT

An antifungal composition showing broad antifungal activity includes at least one peptidic fragment with antifungal activity. The composition has a broad antifungal spectrum and could be used as a food, cosmetic, coating and/or paint, or to enhance the antifungal properties of other antifungal agents in these products, or any other application where broad antifungal activity is required. Several peptidic fragments and their possible modifications to ensure optimal activity are detailed. Methods for producing and formulating the antifungal composition are also disclosed.

### CROSS-REFERENCE TO RELATED APPLICATIONS

This application is a continuation application of U.S. patent application Ser. No. 17/660,969, filed on Apr. 27, 2022, which is a continuation application of PCT International Application Number PCT/US2020/059410, filed Nov. 6, 2020, designating the United States of America and published in the English language, which is an International Application of and claims the benefit of priority to U.S. Provisional Application No. 62/932,613, filed Nov. 8, 2019, the disclosures of which are hereby expressly incorporated by reference in their entireties.

### REFERENCE TO SEQUENCE LISTING

The present application is being filed along with a sequence listing in electronic format. The sequence listing is provided as a file entitled GEAE.005C2.xml, created Apr. 18, 2024, which is 216,808 bytes in size. The information in the electronic format of the sequence listing is incorporated herein by reference in its entirety.

### FIELD

The present disclosure relates to antifungal compositions having enhanced antifungal activity. The compositions disclosed herein have broad antifungal spectrum and are used as a preservative in food, cosmetic, coating and/or paint applications, or to enhance the antifungal properties of other antifungal agents in these products, or any other application where broad antifungal activity is required.

### BACKGROUND

Bacterial and fungal contaminations are a key issue to be addressed in hospitals, pharmaceutical, cosmetics and food industries, among others, where surfaces, environment, and materials must comply with strict sanitary standards.

For example, yeasts and molds play a major role in spoilage of different types of dairy and bakery products, leading to high economic losses for producers and consumers. Chemical preservatives like organic acids and their salts (e.g. sorbate and propionate) are used to preserve these products to protect and prolong their shelf life. Drawbacks in using chemical preservatives are the labeling requirements (often as E numbers) and potential adverse effects on the sensory properties of foodstuff.

Fungal contamination of food (Snyder & Worobo, 2018), cosmetic (Lundov et al., 2009), and painted/coated surfaces (Parjo et al., 2015; Abdel-Rahim et al., 2019) are well established problems for industrial producers and consumers.

In general, current antifungal additives produced by chemical methods do not comply with “organic” certifications and “clean label” standards for foods, cosmetics and drugs. Although for paintings and surfaces most of the certifications and standards do not apply, the organic non-food market is also a growing market.

Fungal strains can also develop resistance mechanisms to commonly used antifungals, such as weak organic acids (Cottier et al., 2015). Six-cysteine containing hevein-type proteins bind chitin present in the fungal cell-wall, and are effective for inhibiting fungal growth in vivo and in vitro (Slavokhotova et al., 2017; Rogozhin et al., 2018).

### SUMMARY

Embodiments provided herein relate to antifungal compositions, and methods of making and using the compositions to inhibit fungal growth.

Some embodiments provided herein relate to antifungal compositions. In some embodiments, the compositions include one or more antifungal peptidic fragments containing a conserved amino acid sequence motif as set forth in SEQ ID NO: 166. In some embodiments, the conserved amino acid sequence motif provides antifungal properties to peptides and/or proteins of interest. In some embodiments, the peptides and/or proteins of interest include any peptide or protein having a conserved amino acid sequence motif as set forth in SEQ ID NO: 166. In some embodiments, the peptides and/or proteins of interest are peptides having an amino acid sequence as set forth in any one or more of SEQ ID NOs: 1-29.

In some embodiments, the compositions include one or more antifungal peptidic fragments. In some embodiments, the antifungal peptidic fragments have an amino acid sequence as set forth in any one of SEQ ID NOs: 1-29, or having a conserved amino acid sequence as set forth in SEQ ID NO: 166, or having an amino acid sequence as set forth in SEQ ID NOs: 30-165. In some embodiments, the composition further includes one or more antifungal additives. In some embodiments, the relative amounts of the one or more antifungal peptidic fragments and the one or more antifungal additives are in an amount sufficient to enhance the overall antifungal activity of the antifungal composition. In some embodiments, the composition further comprises carrier fusion proteins comprising a fusion between the one or more antifungal peptidic fragments and a carrier protein. In some embodiments, the relative amounts of the one or more antifungal peptidic fragments and the carrier fusion proteins are in an amount sufficient to produce a synergistic effect on the overall antifungal activity of the composition. In some embodiments, the carrier protein is a maltose binding proteins (MBP), a glutathione S-transferase, a thioredoxin, a transcription elongation factor NusA (NusA), a thiol disulfide oxidoreductases (DsbA), or a small ubiquitin-like modifier.

In some embodiments, the one or more antifungal peptidic fragments are isolated from natural sources such as plants, seeds, or extracts thereof. In some embodiments, the one or more antifungal peptidic fragments are isolated from an edible plant or seed. In some embodiments, the composition includes one or more antifungal peptidic fragments and one or more antifungal additives, wherein one or more of said antifungal peptidic fragments are derived from a plant, seed, or extracts thereof. In some embodiments, the one or more antifungal additives are derived from plants belonging to families Brassicaceae (Cruciferae), Compositae, Leguminosae, Amaranthaceae, Hitpocastanaceae, Saxifragaceae, Gramineae and Alliaceae, Vitaceae, Theaceae or from the genuses: Raphanus, Heuchera, Aesculus, Clitoria, Brassica, Briza, Sinapsis, Cnicus, Allium, Amaranthus, Impatiens, Mirabilis and Capiscum or from seeds or derivatives thereof. In some embodiments, the one or more antifungal peptidic fragments are produced from a recombinant organism, and wherein the one or more antifungal peptidic fragments are present in a crude protein extract or as a purified antifungal protein. In some embodiments, the one or more antifungal peptidic fragments show greater than 85% sequence similarity, preferably greater than 90% sequence similarity, more preferably greater than 95% sequence similarity with any of the amino acid sequences as set forth in any one of SEQ ID NOs: 1-29 or any one of SEQ ID NOs: 30-165. In some embodiments, the antifungal composition maintains activity after exposure to 90° C. In some embodiments, the one or more antifungal peptidic fragments further comprise flanking regions of two to six charged amino acids, wherein the charged amino acids are selected from arginine, lysine, and histidine residues for positively charged peptides, or wherein the charged amino acids are selected from aspartic acid and glutamic acid for negatively charged peptides.

Some embodiments provided herein relate to methods for inhibiting fungal growth. In some embodiments, the methods include contacting a product or product component with a fungicidally effective amount of any of the antifungal compositions as set forth herein. In some embodiments, the product is a foodstuff, cosmetic, paint, or coating. In some embodiments, the product component is a surface, a packaging, or a productive environment.

Some embodiments provided herein relate to antifungal compositions obtained by a mixed fermentation process with a recombinant microorganism that is configured to produce an antifungal peptidic fragment having an amino acid sequence as set forth in any one of SEQ ID NOs: 1-29 or an antifungal peptidic fragment having a conserved amino acid sequence as set forth in SEQ ID NO: 166, or an amino acid sequence as set forth in any one of SEQ ID NOs: 30-165. In some embodiments, the composition is obtained from extracts from Brassicaceae (Cruciferae), Compositae, Leguminosas, Amaranthaceae, Hitpocastanaceae, Saxifragaceae, Gramineae and Alliaceae, Vitaceae, Theaceae or from the genuses: Raphanus, Heuchera, Aesculus, Clitoria, Brassica, Briza, Sinapsis, Cnicus, Allium, Amaranthus, Impatiens, Mirabilis and Capiscum or from seeds or derivatives thereof.

### BRIEF DESCRIPTION OF THE DRAWINGS

In order to describe the manner in which the above-recited and other advantages and features of the invention can be obtained, a more particular description will be rendered by reference to specific embodiments thereof which are illustrated in the appended drawings. Understanding that these drawings depict only exemplary embodiments and are not therefore to be considered to be limiting of its scope, the invention will be described and explained with additional specificity and detail through the use of the accompanying drawings in which:

FIG. 1. Fungal inhibition in agar plates containing a composition comprising Antifungal Peptide SEQ ID NO: 1 after 2 days at 30° C. Fungal strains inoculated in the plate: 1: Trichoderma reesei; 2: Fusarium oxysporum; 3: Rhizopus oligosporum; 4: household environmental isolated; 5: Aspergillus niger; 6: bread contamination environmental isolate. Panel A: 150 μg/ml of peptidic antifungal composition with six histidine amino-terminal residues. Panel B: 150 μg/ml of peptidic antifungal composition with six histidine amino-terminal residues pre-treated for 10 minutes at 90° C. Panel C: 175 μg/ml of peptidic antifungal composition fused to a carrier protein. Panel D: negative control without peptidic antifungal composition.

FIG. 2. Growth inhibition assay of six fungal species using antifungal peptide SEQ ID NO: 1 bound to different fusion proteins embedded in the solid potato dextrose agar medium (PDA). Representative image of the duplicate assay. PDA culture medium was mixed with its double of its concentration with twice the concentration of the fusion to be used. 100 μg/mL, 150 μg/mL, 200 μg/mL and 400 μg/mL of fusion proteins of SEQ ID NO: 1-MBP, SEQ ID NO: 1-LL-DsbA, and SEQ ID NO: 1-NusA peptide-protein fusion were used. 20,000 spores of each fungal species described in the upper right corner of the figure were inoculated. Plates were incubated for 72 hours at 30° C. In the negative control, the fungi were inoculated on the PDA plate mixed with the dialysis buffer (without peptide or protein). In the positive control, the fungi were inoculated on the PDA plate mixed with 200 μg/mL of zeocin.

FIG. 3. Quantification of the mycelium diameter of the growth inhibition assay of the fungal species with peptide-protein fusion SEQ ID NO: 1-MBP shown in FIG. 2. Bar graphs show the length of each mycelium diameter. Error bars correspond to the standard deviation of the duplicate.

FIG. 4. Quantification of the mycelium diameter of the growth inhibition assay of the fungal species with peptide-protein fusion SEQ ID NO: 1-LL-DsbA shown in FIG. 2. Bar graphs show the length of each mycelium diameter. Error bars correspond to the standard deviation of the duplicate.

FIG. 5. Quantification of the mycelium diameter of the growth inhibition assay of the fungal species with peptide-protein fusion SEQ ID NO: 1-NusA shown in FIG. 2. Bar graphs show the length of each mycelium diameter. Error bars correspond to the standard deviation of the duplicate.

FIG. 6. Growth inhibition assay of six fungal species using the peptide-protein fusion SEQ ID NO: 1-MBP antifungal peptide-protein fusion embedded in the solid medium of PDA. Fungal strains, 1: Trichoderma reesei; 2: Fusarium oxysporum; 3: Rhizopus oligosporum; 4: household environmental isolated; 5: Aspergillus niger; 6: bread contamination environmental isolate. Representative image of the growth inhibition assay. PDA culture medium with its double of its concentration was mixed with twice the concentration of the fusion Ac2-MBP. A final concentration of 800 μg/mL and 1450 μg/mL of the Ac2-MBP was used. 20,000 spores of each fungal species described were inoculated. Plates were incubated for 72 hours at 30° C. Negative control: the fungi were inoculated on the PDA plate mixed with dialysis buffer (without fusion protein).

FIG. 7. Quantification of the mycelium diameter of the growth inhibition assay of the fungal species with the peptide-protein fusion SEQ ID NO: 1-MBP shown in FIG. 6. Bar graphs show the length of each mycelium diameter. Error bars correspond to the standard deviation of the duplicate.

FIG. 8. Agar dilution assay to assess the antifungal activity of the peptide-protein fusion SEQ ID NO: 1-MBP against Aspergillus niger. Left, representative images of agar dilution assays performed with serial dilutions of antifungal peptide-MBP fusions added to agar before solidification. Assays tested for the inhibition of mycelial growth from A. niger spores. Protein storage buffer was used as a negative control for growth inhibition, and Zeocin was used as positive control. Right, IC50 values for the peptide-protein fusion SEQ ID NO: 1-MBP. Aggregated results from up to three independent experiments were used to interpolate IC50 from the fitted curve.

FIGS. 9A-9B. Agar dilution assay comparing the antifungal activity of the peptide-protein fusions SEQ ID NO: 28-MBP and SEQ ID NO: 29-MBP against Aspergillus niger. FIG. 9A: Representative images of agar dilution assays performed with serial dilutions of antifungal peptide-MBP fusions added to agar before solidification. Assays tested for the inhibition of mycelial growth from A. niger spores. Protein storage buffer was used as a negative control for growth inhibition, and Zeocin was used as positive control. FIG. 9B: IC50 values for the peptide-protein fusions SEQ ID NO: 28-MBP and SEQ ID NO: 29-MBP. Aggregated results from three independent experiments were used to interpolate IC50 from the fitted curve.

FIG. 10. Evaluation of the antifungal activity of peptide-MBP fusion proteins. Broth dilution assays were performed to determine the minimum inhibitory concentration (MIC) of each peptide against three fungal species. Each peptide-MBP dilution in broth media was tested in duplicate, and growth was assessed visually.

FIG. 11. Representative image of antifungal activity in bread with purified peptide-protein fusion SEQ ID NO: 29-MBP protein and 20.000 spores of fungi Aspergillus flavus in bread (Panel A). As a negative control, a bread without antifungal protein (Panel B) was made. As a positive control was added the antibiotic Zeocin 200 μg/ml (Panel C) on bread. After 14 days of incubation, the growth of the fungus in the bread was evaluated. The experiment was done in triplicate.

FIG. 12. Representative image of antifungal activity in bread with purified peptide-protein fusion SEQ ID NO: 29-MBP protein and 20,000 spores of fungi Aspergillus flavus in bread. After 10 days of incubation, the growth of the fungus in the bread was evaluated. (Panel A) Negative control, a bread without antifungal protein. (Panel B) Close up of hyphae in control bread. (Panel C) SEQ ID NO: 29-MBP at 0.06% w/w. (Panel D) Positive control, Zeocin 200 μg/ml.

FIG. 13. Representative image antifungal assay in bread using a crude extract of Pichia pastoris SEQ ID NO: 29-MBP. Two protein concentrations were added to the bread, corresponding to 0.04% and 0.02% of the total weight. Additionally, 20,000 spores of fungi Aspergillus niger was added in all cases. As a negative control, a bread without antifungal crude extract of protein (0%) was made. After 4 and 6 days of incubation, the fungal growth in the bread was evaluated.

FIG. 14. RMSD and relative binding energies for SEQ ID NO: 1-MBP. RMSD time-series data for SEQ ID NO: 1-MBP across two replicate simulations. Different configurations were obtained at different simulation times, and an MM/PBSA calculation was performed for each configuration. Relative binding free energies are shown at the bottom for each of the configurations depicted in the RMSD plot for each replica.

FIGS. 15A-15B. Contact analyses for SEQ ID NO: 1-MBP. FIG. 15A: Sample snapshots from the configurations used in the analyses of binding energies for SEQ ID NO: 1-MBP (replicas 1 and 2). Residue numberings are shown for the residues that are visually close to the chitin surface. FIG. 15B: Per-residue percentage of contact for SEQ ID NO: 1-MBP residues across the entire simulation, for both replica 1 and 2, using a distance cut-off of 4.5 Å.

FIG. 16. RMSD and relative binding energies for SEQ ID NO: 28-MBP. RMSD time-series data for the SEQ ID NO: 28-MBP peptide variant across two replicate simulations. Different configurations were obtained at different simulation times, and an MM/PBSA calculation was performed for each configuration. Relative binding free energies are shown at the bottom for each of the configurations depicted in the RMSD plot for each replica.

FIGS. 17A-17B. Contact analyses for SEQ ID NO: 28-MBP. FIG. 17A: Sample snapshots from the configurations used in the analyses of binding energies for the SEQ ID NO: 28-MBP variant (replica 1 and 2). Residue numberings are shown for the residues that are visually close to the chitin surface. FIG. 17B: Per-residue percentage of contact for SEQ ID NO: 28-MBP residues across the entire simulation, for both replica 1 and 2, using a distance cut-off of 4.5 Å.

FIG. 18. RMSD and relative binding energies for SEQ ID NO: 29-MBP. RMSD time-series data for the SEQ ID NO: 29-MBP peptide variant across two replicate simulations. Different configurations were obtained at different simulation times, and an MM/PBSA calculation was performed for each configuration. Relative binding free energies are shown at the bottom for each of the configurations depicted in the RMSD plot for each replica.

FIGS. 19A-19B. Contact analyses for SEQ ID NO: 29-MBP. FIG. 19A Sample snapshots from the configurations used in the analyses of binding energies for the SEQ ID NO: 29-MBP variant (replicas 1 and 2). Residue numberings are shown for the residues that are visually close to the chitin surface. FIG. 19B Per-residue percentage of contact for SEQ ID NO: 29-MBP across the entire simulation, for both replica 1 and 2, using a distance cut-off of 4.5 Å.

FIG. 20. Schematic representation of the simulated systems. The system setup was similar for all antifungal peptide variants analyzed. A chitin surface was built using 14 polymers formed by 7 N-acetylglucosamide monomers. The system was solvated in water, electro-neutralized in NaCl, and left at a concentration of 150 mM.

FIG. 21. Sequence alignment of antifungal peptides SEQ ID NOs: 1-29, and highlighted conserved sequence motif having an amino acid sequence as set forth in SEQ ID NO: 166.

### DETAILED DESCRIPTION

All publications, patents, and patent applications mentioned in this specification are herein incorporated by reference to the same extent as if each individual publication, patent, or patent application was specifically and individually indicated to be incorporated by reference.

In the description that follows, the terms should be given their plain and ordinary meaning when read in light of the specification.

The subject specification contains amino acid sequence information. Each amino acid sequence is identified in the sequence listing by the numeric indicator <210> followed by the sequence identifier (eg. <210>1, <210>2, etc.). The length, type of sequence (amino acid, DNA, etc.) and source organism for each sequence is indicated by information provided in the numeric indicator fields <211>m<212> and <213>, respectively. Amino acid sequences referred to in the specification are identified by the indicator SEQ ID NO: followed by the sequence identifier (e.g. SEQ ID NO: 1, SEQ ID NO: 2, etc). The sequence identifier referred to in the specification correlates to the information provided in numeric indicator field <400> in the sequence listing, which is followed by the sequence identifier (e.g. <400>1, <400>2, etc). That is SEQ ID NO: 1 as detailed in the specification correlates to the sequence indicated as <400>1 in the sequence listing.

“About” as used herein when referring to a measurable value is meant to encompass variations of ±20% or ±10%, more preferably ±5%, even more preferably ±1%, and still more preferably ±0.1% from the specified value.

Fusions of peptides and proteins are referred to herein as peptide-protein fusions, and can include, for example, an indicator of sequence followed by a protein, for example, SEQ ID NO: 1-MBP refers to a fusion of the amino acid sequence identified herein as SEQ ID NO: 1 fused to maltose binding protein (MBP).

Purified or crude extracts of recombinant hevein-type proteins could substitute or potentiate current antifungals used in the food, cosmetic, and coating products. These peptide antifungals in food, cosmetics and drugs would comply with “organic” certifications and “clean label” standards.

It is an object of the disclosure to provide an improved wide spectrum antifungal agent based on at least one peptidic fragment as well as preparations and compositions thereof. The term “wide spectrum” as used herein has its ordinary meaning as understood in light of the specification, and includes the ability of the compositions provided herein to inhibit the growth of species of the fungal kingdom, spanning species in all phyla including but not restricted to Microsporidia, Chytridiomycota, Blastocladiomycota, Neocallimastigomycota, Glomeromycota, Ascomycota, and Basidiomycota, and the species within these phyla.

The antifungal peptides may be synthesized chemically or produced using recombinant DNA technology using methods well known in the art. Where the antifungal peptide is produced using recombinant techniques in a microorganism host and if it is applied to a foodstuff, the host used for the transformation and production of the desired peptide will be a GRAS (Generally Recognized As Safe) organism. GRAS organisms being those organisms such as, yeast, Pichia, lactic acid bacteria and certain E. coli strains which are regarded by the Regulatory Authorities as being “safe”. Protein fragments thus produced using GRAS organisms may then be purified and added to the antifungal agent that can be incorporated directly or in a composition comprising other active components into the final products (foodstuff, cosmetics, drugs, paintings and/or coatings). Alternatively, antifungal peptides for non-food applications can be produced in non-GRAS hosts.

Another advantage of the antifungal composition from this disclosure is that it maintains activity after exposure to 90° C. for two hours. Therefore, it can be added to products that need to be processed at high temperatures.

Contamination in foodstuff due to the presence of common food spoilage organisms is a recurring problem in the food industry. Most surprisingly, it was discovered that when the antifungal agent of the present disclosure is combined with food, antifungal activity was observed. This effect makes it possible to use a reduced amount of the antifungal agent of the present disclosure as a food additive present in a foodstuff. This is particularly advantageous since it is highly desirable to minimize the amount of any additive present in foodstuff both for human and animal consumption.

Accordingly, some embodiments provided herein relate to antifungal compositions. In some embodiments, the antifungal compositions include one or more antifungal peptide fragments. In some embodiments, the relative amounts of the antifungal peptide fragment(s) are present in an amount sufficient to enhance the overall antifungal activity of the composition.

In some embodiments, the antifungal compositions include at least one, or preferably at least two, peptidic fragments having any of the sequences shown in Table 1 and/or Table 2.

In some embodiments, the antifungal compositions include one or more peptides having each of the sequences as shown in Table 1 and/or Table 2.

TABLE 1

| SEQ ID | |
|---|---|
| NO: | AMINO ACID SEQUENCE |
| 1 | VGECVRGRCPSGMCCSQFGYCGKGPKYCGR |
| 2 | GECNMYGRCPAGYCCSKYGYCGLGPAYCGD |
| 3 | IGECQKHKKCPKGMCCSYAGYCGTGSAYCG |
| 4 | PAVAQNCNCPAGMCCSQWGYCGTGPDYCGA |
| 5 | QQGACNNGHCPAGLCCSRFNFCGSGPAYCG |
| 6 | AEQCGRQSGKRKCPNKLCCSKFGWCGTSCD |
| 7 | AVAQSCGCPAHLCCSQWGFCSTGPDYCGAG |
| 8 | CGKAAGGKVCTNNYCCSKWGSCGIGPGYCG |
| 9 | GACGPNRSCRPGLCCSRFNYCGSGPAYCGR |
| 10 | AAAQNCGCQDGYCCSQWGYCGTTEAYCGQG |
| 11 | KQGHGLKCLDGMCCSIWGWCGNTQEYCAPG |
| 12 | ASGALCANGLCCSQYGYCGTTPAYCGPGCQ |
| 13 | QQCGSQAGGALCANGLCCSEYGYCGTTTAY |
| 14 | QQCGSQAGGALCANGLCCSQYGYCGTTTAY |
| 15 | CRAGVKECPEDECCSIWGWCGVTERYCGHD |
| 16 | GECVRGRCPGGLCCSKFGFCGSGPAYCG |
| 17 | SAAGPAVAQNCNCPAGMCCSQWGYCGTGPDYCGAGCQS |
| 18 | SAAGPAVAQNCNCPAGMCCSQWGYCGTGPDYCGAGCQS |
| 19 | VGPGGECGGRFGGCAGGQCCSRFGFCGSGPKYCAH |
| 20 | SGPNGQCGPGWGGCRGGLCCSQYGYCGSGPKYCAH |
| 21 | AAGQCYRGRCSGGLCCSKYGYCGSGPAYCG |
| 22 | MGQQGACGPSRSCRPGLCCSRFNYCGSGPAYCGRATP |
| 23 | TSIASGECNMYGRCPAGYCCSKYGYCGLGPAYCGDAEQQ |
| 24 | SMAQQGACNNGHCPAGLCCSRFNFCGSGPAYCGGAEEQ |
| 25 | SMGQQGACGPNRSCRPGLCCSRFNYCGSGPAYCGRATA |
| 26 | MAFQCGRQAGGARCPGGLCCSQYGYCGTTSQYCGRGQCQGQC |
| 27 | APGACGEQAGGKECPSGLCCAQWGFCGSGPEYCGV |
| 28 | VQDWCGNDCSAKECCKRDGYCGWGVDYCGG |
| 29 | KRCGSQAGCPNGHCCSQYGFCGFGPEYCGRG |
| 166 | CXXGXCCSX+G+CG |

TABLE 2

| SEQ | |
|---|---|
| ID | |
| NO | AMINO ACID SEQUENCE |
| 30 | VLYTGQCFKKDNICKYKVNGKQNIAKCPSAANKRCEKDKNKCTFDSYDRKVTC |
| 31 | ATYNGKCYKKDNICKYKAQSGKTAICKCYVKKCPRDGAKCEFDSYKGKCYC |
| 32 | LSKYGGECSKEHNTCTYRKDGKDHIVKCPSADNKKCKTDRHHCEYDDHHKTVDCQTPV |
| 33 | MDGYIKRRDGCKVACLIGNEGCDKECKAYGGSYGYCWTWGLACWCEGLPDDKTWKSET |
| 34 | DTCGAGYDPAQRRTNSPCQASNGDRHFCGCDRTGIVECKGGKWTEIQDCGRNSCHGGTEGGAKC |
| 35 | DTCGSGYNVDQRRTNSGCKAGNGDRHFCGCDRTGVVECKGGKWTEVQDCGSSSCKGTSNGGATC |
| 36 | VLYTGQCFKKDNICKYKVNGKQNIAKCPSAANKRCEKDKNKCTFDSYCRKVTC |
| 37 | LSKYGGECSKEHNTCTYRKCGKDHIVKCPSADNKKCKTDRHHCEYDDHHKTCDCQTPV |
| 38 | LEKYGGECSCECNTCTYRKDGKDHIVKCPSADNRKCKTDRHHCEYDDHHKTVDCQTPV |
| 39 | LSKYGGECSKTHNTCTYRKDGYDHIVKCPSADNKCCKTDRHHCEYDDHHATVDCQTPV |
| 40 | LSKYGGECSKEHNTCTYRKDGKDHQCKCHSRDNKKCKTDRHHCEYDDHHKTVDCQTPV |
| 41 | LSCYGGECAKEHNTCTYRKDGLDHIVKCPSADNKKCKTCRHHCEYDDHHKTVDCQTPV |
| 42 | LSCYGGNCSCEHNTCTYRKDGKDHICKCPSADNKKCKTDRHHCEYDDHHKTVDCQTPV |
| 43 | LSKYGGECSKEHNTCTYRKDGKDHCVKCPSADNKKCKTDRHHCEYDDHHTTVDCQRPR |
| 44 | LSKYGGECCKEHNTCTYFKDGKDHIVKCPSADNKQCKTDRHHCEYDDHHKTVCCQTPV |
| 45 | LSKYGGECCKEHNTCTYRKDGKDHIVKCPSADNKKCLTDRHHCEYDDHHCKVDCQTPV |
| 46 | LAKYGGECKKEHNTCTYCKDGKDHIVKCPSPDNKKCKTDRHHCEYDDHHKTVDCQTPV |
| 47 | LSKYGGECSKEHNTCTARKDGKDHIVKCPSADCKKCKTDRHHCYYDEHHKTVDCQTPV |
| 48 | LSKYGGECSTEHNTCAYRKDGKDHIVKCPSADNKKCKTDRHHCEYDDHHKTVCCQTPC |
| 49 | LSKYGGECSKEHNTCTYRKDMKDHAVKCPSADNKKCKTDRHCCEYDKHHKTVDCQTPV |
| 50 | LSKYGIECSKEHNTCTYRKDGKDHIVKCESADNKKCKWDRHHCEYDCHHKTVDCQTPV |
| 51 | LSKRGGECSKEHNTCTYRKDGKDHIVKCPSADNKKCKCDRHHCECDDHHKTVDCQGPV |
| 52 | LSKYGAECDKEHGTCTYRKDGKDHICKCPSADNKKCKTDRHHCEYDDHHKTVDCQTPV |
| 53 | LSCYGGECSKEHNYCTYRKDGKDHIVKCPSADNKKCKTDNPHCEYDDHHKTVDCQTPV |
| 54 | LSKGGGECSKEHNTCTYRKDGKDHDVKCPSADNKKCKTDRHHCEYDDHFKCVDCQTPV |
| 55 | LAKYGGECSKEHNTCYYRKDGCDHIVKCPSADNKKCKTDRHHCEYDDHHKTVECQTPV |
| 56 | LSKYGGECSKEHNTCCYFKDGKDHIVKCPSADNKKCYTDRHHCEYCDHHKTVDCQTPV |
| 57 | LSKYGGECSKEHNTCTYRWDGADHIVTCPSADNKKCKTDRHHCEYDDHHKTVDCLTPV |
| 58 | LSKYGGECSKEHNTCTYRKDGKDHIVKCPSADEKKCKTDRHCCEACDHHKTVDCQTPV |
| 59 | LQKYGGNCSKEHNTCTYRKDGKDHIVKCPSADNKKCKTDRHHCEYDDHHKAVDCCTPV |
| 60 | LSKYGGECSKEHNTCCYRKDGKAHEVKCPSAFNKKCKTDRHHCEYDDHHKTVDCQTPV |
| 61 | LSKYGGECSAPHNTCTYRKDGCDHIVKCPSADNKKCKTDRHHCEYNDHHKTVDCQTPV |
| 62 | LSKYGGECSKHHNTCTYRKDGKDHWVKCPSADNKKCKTDRHHCEYADHHKTVDCQTCV |
| 63 | LSKYGGECWKEHNTCTEQKDGKDHIVKCPSADNKKCKTDLHHCEYDDHHKTVDCQTPV |
| 64 | LSKCGGECSKEHNVCTYRKDGKDHIVKCCSADNKKCKADRHHCEYDDHHKTVDCQTPV |
| 65 | LSKYGGECSKEHNTCTYRKDGKDHIVKCPSADNKSCKIDCHHCEYDDHHKTVDCQAPV |
| 66 | LSKYGGECSKEMNTCTYRKDGKAHIVKCPSADNKKCKTDRHVCCYDDHHKTVDCQTPV |
| 67 | LSKYGDECSKEHNTCTYVKDGKDHIVKCPSADNKKCKTDRHHCECDDHHKAVDCQTPV |
| 68 | LSKYGWECSKEHNTCTFRCDCKDHIVKCPSADNKKCKTDRHHCEYDDHHKTVDCQTPV |
| 69 | LSKYGGECSKEANTCTYRADGKDHIVKCPSADNKKCKCDRHHCEYDDHHKTVDCQTPA |
| 70 | LSKEGGECSKEHNTCTYRKDGKDHIVKCPSADNKKCCRDRFHCEYDDHHKTVDCQTPV |
| 71 | LSKYHGECSKEHNTCTYRKDGKDHIVCCPSADNKKCKTQRHHCEYDDHHATVDCQTPV |
| 72 | LSKYGGECSKEHNTCTYRADGKDHIVKCPSADNKKCKTCRHHCEYDDHHKAVDCQTGV |
| 73 | LSKYGGCCSKEHNTCTERKDGKDHIVKCPSADNKKCKTDRHHCEYDDHHKTVDCQSPA |
| 74 | LSKYGGACSKEHNTCTYRKDGKDCIVKCPSADNKKCKWDRHHCEYDDNHKTVDCQTPV |
| 75 | LSKGGGECSKEHNTCTYRKDGKDHIVKCRSADNKACKTDRQHCEYDDHHKTVDCQTPV |
| 76 | LSKAGGECSKFHNTCTYRKDGDDHICKCPSADNKKCKTDRHHCEYDDHHKTVDCQTPV |
| 77 | LWKYGGECSKEHNKCTNRKDGKDHIVKCPSADNKKCKTDRHHCEYDDHFKTVDCQTPV |
| 78 | LSFYGGECSKEHNTCTYRKDGKDHIVKCPSADNKKCKIDRAHCEYDDHHCTVDCQTPV |
| 79 | LSCHGAECSKEHNTCTYRKDGKDHIVKCPSADNKKCKTDRHHCDYDDHHKTVDCQTPV |
| 80 | LSKYGGECQKEHNTCTYRKDAKDHCVKCPEADNKKCKTDRHHCEYDDHHKTVDCQTPV |
| 81 | LSKYGGECSKEDNTCTYRKDGKDHIVKCPSADNKKCCTDRHHCEYDDHHKTVDCQKPN |
| 82 | LSKYGGECSKEMGTCTYACDGKDHIVKCPSADNKKCKTDRHHCEYDDHHKTVDCQTPV |
| 83 | LVKYGGECSKEHWTCTYRKDGKCHIVKCPSADNKKCKTDRHHCEYDDAHKTVDCQTPV |
| 84 | LQKYGGECSKEHNTCWYRKDGKDHIVKCCSADNKKCKTDRHHCEYDRHHKTVDCQTPV |
| 85 | LSKYGGECSKEHNTCCYRKDGKDHIVCCPSRDSKKCKTDRHHCEYDDHHKTVDCQTPV |
| 86 | LSKYGGECSKECNTCTYRKDGKDHIVKCPSADNKNCKTDRRHCEYDDHHSTVDCQTPV |
| 87 | LSKYGGECSCEHNTCTYRKDGKDHIVKCPSADAKKCKTDRHHCEYDDGHKTVDCQTPA |
| 88 | CSKYGGECCKEHNTCTYRKDGFDHISKCPSADNKKCKTDRHHCEYDDHHKTVDCQTPV |
| 89 | LSKYGGECSKAHGTCTYRKDGKDDIVCCPSADNKKCKTDRHHCEYDDHHKTVDCQTPV |
| 90 | LSKYGGECSKEHNTCTYRKDGKDHIVKCPSQDNKKCKTDRHHCCYDDHHKTVDCQEPD |
| 91 | LSKYGGECSKEHNTCTYRKDGKDHIVKCPAADNKKCKTDCHHCEYTDHHKTVDCQTEV |
| 92 | LGAYGGECSKEHNTCTYRKDGKDHIVKCPSCDNKKCKTDRHHCEYDDHGKTVDCQTPV |
| 93 | LSKYHGECAKEHNTCVYRKDGKDHIVKCPSADNKKCKTDRHHCEYDDHHKTVDCVTPV |
| 94 | LSKYGGECSKAHNTCTYRKDGRDHIVKCPSADNKKCKTDRHHCEYDDHHKCVDCKTPV |
| 95 | LSKYGGECSKEHNTCTYRKDVKDHIVKCASADNDKCKTDRHHCCYDDHHKTVDCQTPV |
| 96 | LNKYGGECSKEHVTCTYRKDGKDAIVKCPSADNKKCKTCRHHCEYDDHHKTVDCQTPV |
| 97 | LSKYGGECSKEHNNCTYRKDGVDHIVKCPSWDNCKCKTDRHHCEYDDHHKTVDCQTPV |
| 98 | LSKYGGECAKEHNTCTYRKDGKDCIVKCPSADNKKCKTDRHHCEYDDHHKHVICQTPV |
| 99 | LSKYGGECSKEHNDCTYRKDGKDHIVMCPSADNKKCKTDRHHCEYDDHCKAVDCQTPV |
| 100 | LSKYGGECSKEHNTCTYRCDGKDHIVKCPSAVNKKCKTARHHCEYDAHHKTVDCQTPV |
| 101 | LSKYGGECSKEHNTCTYRKDGKDHICKCPSAANKKCKLDRHHCEYDDHHKTVDCGTPV |
| 102 | LSKYGGECGREHNTCTYRWDGKDHIVKCPSADNKKCKTDRHHCEYCDHHKTVDCQTPV |
| 103 | LSKYGYECSKWHNTCTYRKDGKDHIVKCPSVDNKKCKTDRHHCEYDDHHKTVDCQTFV |
| 104 | LSKYGGECSKEHNTCTYRKDGKDHIEKCPSADNKPCATDRHHCEYDDHHKCVDCQTPV |
| 105 | ASKYGGECSKEENTCTYRKDGKCHIVKCPSADNKKCKTDRHHCEYDRHHKTVDCQTPV |
| 106 | LSKYGGECSIEHNTCTYRKDGKDHIVKCPDRDNKKCKTDRHHCEYDDHHKTVDCQTCV |
| 107 | LSKYGGECSKEHNTCTYLKDGKDHIAKCPSAPCKKCKTDRHHCEYDDHHKTVDCQTPV |
| 108 | LSKYGGWCSKECNTCNYRKDGKDHNVKCPSADNKKCKTDRHHCEYDDHHKTVDCQTPV |
| 109 | LSKYGGECSKEHNTCTYRKDAKDHIVKCPSADNKKCKTDCHHCFYDDHHKAVDCQTPV |
| 110 | LSKQGGECSKEHNTCTYRKDGKDCIVKCPSAANKKCKTHRHHCEYDDHHKTVDCQTPV |
| 111 | LIKYGGECSYEHNTCTERKDGKDHIVKCPSADNKKCKTDRHACEYDDHHKTVDCQTPV |
| 112 | LSKYGGECHKEHNCCTYRKDGKDHIVKCPSCDQKKCKTDRHHCEYDDHHKTVDCQTPV |
| 113 | LSKYGGECRKEHNTCTYRKDGKDHIVKCPSADNKKCKGDRHHCEYDDLHKTVDCQTPC |
| 114 | LSKYGLECSKEHNTCTYRKDGKDHIVKCASADNKKCKTDRHHCEYDDHHKTVCCQTYV |
| 115 | LSKYGGECSKEHNTCTYRKDGKACIVKCPSADNKKCKTDRHHCEYDSHHKTVDCQTPF |
| 116 | LSKYGGECSKEHNCCPYRKDGKRHIVKCPSADNKKCKTRRHHCEYDDHHKTVDCQTPV |
| 117 | LSKYGGECSCEHNTCTYRKDGKDHNVKCPSTDNKKCKTDRHHCEYDDHHKTVGCQTPV |
| 118 | LSKYGGECSKEHNTCTYRKDGKDHICRCPAADNKKCKTDRHHCEYDDHHCTVDCQTPV |
| 119 | LSKYGGECSKEHNTCTYRKDCADHIVKCPTADNKKCKHDRHHCEYDDHHKTVDCQTPV |
| 120 | LSKYDGECSKEHNTCTYRKDGKSHIVKCPSADNKKCKTDRHHCEADDHHCTVDCQTPV |
| 121 | LSKGGGECSKQHNTCTYRKDGKDHIVKCPSADNKKCKFDRHHCEYDDHHKTVDCQTSV |
| 122 | LSKYGGECSKEANTCTYRKDGKDHICKCPSADNKKCKTFRHHCEYQDHHKTVDCQTPV |
| 123 | LSKYGGECSKEHCTCGDRKDGKDHIVKCPSADNKKCCTDRHHCEYDDHHKTVDCQTPV |
| 124 | LSKYGGECSKEHNTCTYRKDAHDHIVKCHSADNKKCKTDRHHCECDDHHKTVDCQTPV |
| 125 | LSKYGGECSKEHNTCTYRKDGKDHIVKCPSADNCKCKTARHHCEFDDHHKTVPCQTPV |
| 126 | LSRYGGECSKEHNTCTYRKDGCDHIVKCPSMDNKKCKTDRHHCEIDDHHKTVDCQTPV |
| 127 | LSKYGGECSKEHNTCTYRKDGKDCIVWCPSADNKKCKTDRHHCMYDDHHKTVDCQYPV |
| 128 | LSKYGGECSKHHNTCTYRKDGKDPIVKCPSADNKKCKTDHCHCEYDDHHKTVDCQTPV |
| 129 | LSKYGGNCSKEHNTCTARKDGKDHIVKCPSADNKKCKTDDHHCEYADHHKTVDCQTPV |
| 130 | CAKYGGCCSKEHNTCTYRKDGKDHIVKCPSADNKKCKTIRHHCEYDDHHKTVDCQTPV |
| 134 | SKYGGECSKEHNACNYRKDGKDHIVKCPSADNKKCKTDCHHCEYDDTHKTVDCQTPV |
| 135 | LSKYGGECSYEHNTCTYRKDGKDVIVKCPSADWKKCKTDRHHCEYDDHHKTVDCQMPV |
| 136 | LSKYGGGCSKEHNTCTYRKDGKDHIVKCPSADNKACKCDRHHCEYDDHHKTVWCQTPV |
| 137 | LSKYGGACSKEHNTCTYRKDCKDHIVKCPSADNKKCKTDRHACELDDHHKTVDCQTPV |
| 138 | LSKYGCECSKEHNTCTYRKDGKDHAVKCPPADNKKCKTDRHHCEYKDHHKTVDCQTPV |
| 139 | LSKYGGECSKEHNTCTAWKDGKDHIVKCPSADNKKCKWDRHHCEYDDHHKTVDCQTCV |
| 140 | LSKYGGECSKEHNTCTYRKDGKDHIVKCPSCANKKCKTDRHHCEYDDDHKTVDCQCPV |
| 141 | ASKYGGECSDEHNTCTYRKDGKDHIVKCPSADKKCCKTDRHHCEYDDHHKTVDCQTPV |
| 142 | LSKYGGECSKRHNTCTYRKDGKDHIVGCPDADNKKCKTDRHHCEYDDHHKTVCCQTPV |
| 143 | LSCYGGECSKEHNTCTYRKDGKDHIVKCPSADNKKCKTDRHHCEYVDHAMTVDCQTPV |
| 144 | LSKYGCECSKEHNTCTYRKDGKDHIVKCPSADNKKCKGDRHHCEWDDHHKTVDCQTAV |
| 145 | ISKYGGECSKEHNTCTYRKDGKDCIVKCPSADNCKCKTDRHHCEYDDHAKTVDCQTPV |
| 146 | LSKYGGECSKEHNTCTYRNDGKDHIFKCPSADNKKCKTDRVHCEYDDCHKTVDCQTPV |
| 147 | LSKYGGECSKEHNTCTCRKDGKDHIVKCCSADNKKCKTDRHFCEYDDHHKTVDCQTAV |
| 148 | LSKYGGECSKIHNTCTYRKDGKDHITKCDSACNKKCKTDRHHCEYDDHHKTVDCQTPV |
| 149 | LSKYGGECSKEHNTCTYRKDGKVHIVKCASADNKKCKCDRHHCEYDDHHKTVDCTTPV |
| 150 | LSKYGGECSKEHNTCTYRKDGKDSNVKCPAADNKKCKTDRHHCECDDHHKTVDCQTPV |
| 151 | LSKYGGECSKEHNYCTYRKDGKDHIVKCPSADNKKCKTDRHHCEYDVHHKTVDCATPN |
| 152 | LSKYGGECSKEHNTCTYRKDGKDHIVKCPCADCKKCKTDRHHCEYDDSHKTVDCQEPV |
| 153 | LSKYGGECSKEWNTCTYRKDGKDHIVKCPSADNKKCKSDRHHCEYCDHHKTVCCQTPV |
| 154 | LSKYGGECSKEHNTCTYRQDGKDHIVKCPSCDNKKCKTDRHHCEADDHHKTVDCATPV |
| 155 | LSKYGGECSKEVNTCTYRKDGKDHIVKCPSACNKKCATDRHHCEYADHHKTVDCQTPV |
| 156 | LSKYEGECSKEHNTCTYRKDGKDHIVKCPSHDNKKCKTDRHHCERDDCHKTVDCQTPV |
| 157 | LSKYGGECSKEHNTCTYRKDGKDHIVKCPSARNKKCKTDRAHCEYCEHHKTVDCQTPV |
| 158 | LSKYGGECSKESNTCTYRKDGKDHIVKCPSADNKWCKTDRHHCYYRDHHKTVDCQTPV |
| 159 | LSKYGGMCSKEHNTCTYRKDGKDHIVKCPSADCKKCKTDYHHCEYDDHHKTVDCQTPR |
| 160 | LRKYGGECSKEHNTCTYRKDGKWHIVKCPSADNKKCKTHRHHCEYDDHHKCVDCQTPV |
| 161 | LSKYGGECSKAHNTCTYRKDGKDHIVKCPSAINKKCKTDRHHCEYPDHCKTVDCQTPV |
| 162 | LSKYGGECSPEHATCCYRKDGKDHIVKCPSADNKKCKTDRHHCEYDDHHKTVDCQNPV |
| 163 | LSKYGGECSKEHNTCTYRKDGKDHIVKCPSADNKKCKTPRCHCEYDDHHKTVACQAPV |
| 164 | ADKYGGECSKCHNTCTYRKDGKDHIVKCPSADNKKCKTDRHHCEYDDHHKTVDCQTQV |
| 165 | DTCGAGYDPAQRRTNSPCQASNGDRHFCGCDCTGIVECKGGKWTEIQDCGRNSCHGGTEGGAKC |

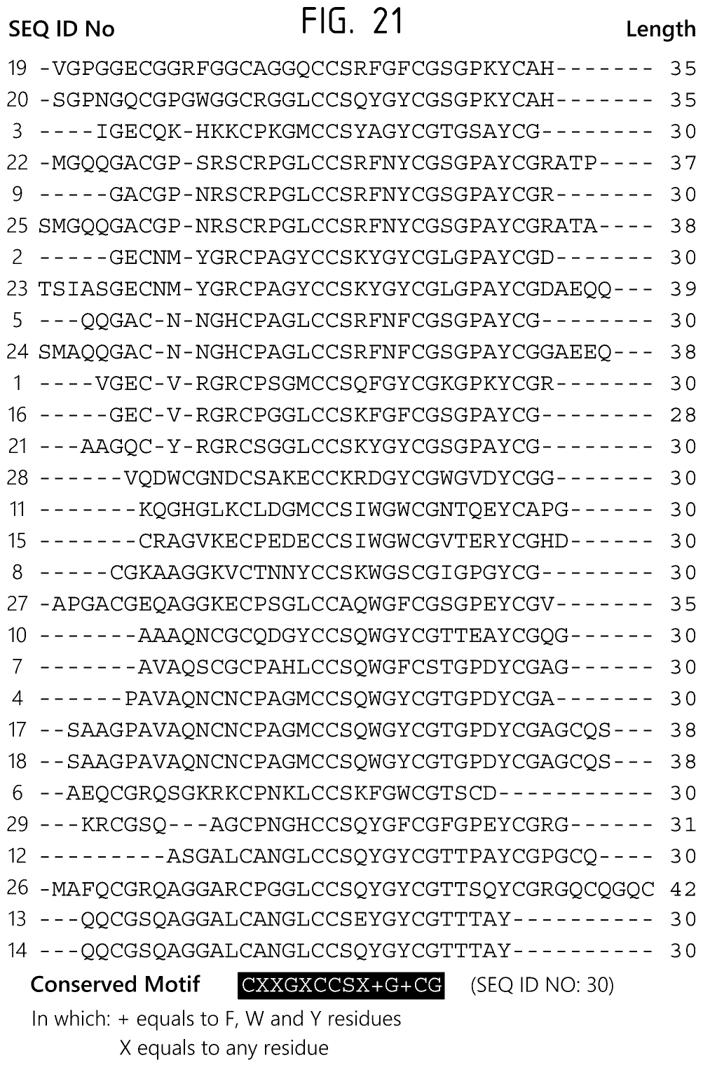

In some embodiments, the antifungal peptides include one or more peptidic fragments containing a conserved amino acid motif found in antifungal peptides SEQ ID NOS: 1-29, as shown in FIG. 21. In some embodiments, the conserved amino acid motif is a motif having an amino acid sequence of CXXGXCCSX+G+CG (SEQ ID NO: 166), wherein C equals to cysteine residues, G to glycine residues, S equals to serine residues, + is aromatic residues such as phenylalanine (F), tryptophan (W) or tyrosine (Y), and X is any amino acid residue. Some embodiments provided herein relate to an antifungal peptide having an amino acid sequence as set forth in SEQ ID NO: 166.

In some embodiments, the compositions provided herein include one or more “carrier fusion proteins” (carriers or carrier proteins) for enhancing solubility. Carrier proteins correspond to any proteins that when genetically fused to the antifungal agent, generate a chimeric protein with enhanced solubility, protein folding and/or production yield. In some embodiments, carriers can be for example, Maltose Binding Proteins (MBP), Glutathione S-transferases, Thioredoxins, Transcription Elongation Factor NusA (NusA), Thiol Disulfide Oxidoreductases (DsbA), or Small Ubiquitin-like Modifiers.

The sequences as set forth in Table 1 and Table 2, including SEQ ID NOS: 1-29, SEQ ID NOs: 30-165, and SEQ ID NO: 166 may be used in any of the compositions as described herein. In some embodiments, the compositions include one or more than one sequence as set forth in Table 1 or Table 2, such as 1-166 of the amino acids, such as 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 101, 102, 103, 104, 105, 106, 107, 108, 109, 110, 111, 112, 113, 114, 115, 116, 117, 118, 119, 120, 121, 122, 123, 124, 125, 126, 127, 128, 129, 130, 131, 132, 133, 134, 135, 136, 137, 138, 139, 140, 141, 142, 143, 144, 145, 146, 147, 148, 149, 150, 151, 152, 153, 154, 155, 156, 157, 158, 159, 160, 161, 162, 163, 164, 165, or 166 of the sequences as set forth in Table 1 and Table 2, in any combination. In some embodiments, the compositions include a variant of any one of the sequences as set forth in Table 1 or Table 2, such as a variant of any one of SEQ ID NOs: 1-29 or SEQ ID NOs: 30-165, having 1, 2, 3, 4, 5, 6, 7, 8, 9, or 10 amino acid variations from the sequences as set forth in SEQ ID NOs: 1-165. In some embodiments, the variant has an amino acid sequence identity of greater than 70% to SEQ ID NOs: 1-165, such as 70, 75, 80, 85, 86, 87, 88, 89, 90, 91, 92, 93, 94, 95, 96, 97, 98, or 99% sequence identity to any one of SEQ ID NOs: 1-165, are a sequence identity within a range defined by any two of the aforementioned values. In some embodiments, the variant of any one or more of SEQ ID NOS: 1-29 retains the conserved amino acid sequence as set forth in SEQ ID NO: 166, wherein any changes to the amino acid sequence is a change outside of the motif, or is a change within the motif within the variations as defined by the motif, for example, wherein the X within the motif of SEQ ID NO: 166 is any amino acid, and wherein the + within the motif of SEQ ID NO: 166 is any one of F, W, or Y.

In some embodiments, the compositions include a fusion of any sequences as set forth in SEQ ID NOs: 1-29, SEQ ID NOs: 30-165, and 166 in combination with a carrier protein.

In some embodiments, the compositions include any one or more of the sequences as set forth in Table 1 and Table 2 with 2 to 6 charged polar amino acids added to the carboxy-terminal and/or amino-terminal regions of the peptide sequences. In some embodiments, additions of the 2 to 6 charged polar amino acids enhance solubility, improve peptide repulsion, and/or decrease peptide aggregation in solution. The charge of these amino acids should be the same as the net charge of the antifungal peptide: For cationic peptides, arginine, lysine and histidine residues can be added either as individually repeated residues or in combinations. For anionic peptides, aspartic acid and glutamic acid residues can be added either as individually repeated residues or in combinations. Thus, for example, any one of SEQ ID NOs: 1-166 can include 2 to 6 charged polar amino acids added to the carboxy and/or amino terminal end, including any one or more of arginine, lysine, histidine, aspartic acid, or glutamic acid in any combination thereof.

In some embodiments, the compositions include peptidic antifungal fragments alone or in mixtures thereof present at a final concentration in between 5 to 5000 μg/ml in liquid products, or 5 to 5000 μg/g in solid products, including, for example, 5, 10, 15, 20, 25, 30, 35, 40, 45, 50, 55, 60, 65, 70, 75, 80, 85, 90, 95, 100, 110, 120, 130, 140, 150, 160, 170, 180, 190, 200, 250, 300, 350, 400, 450, 500, 600, 700, 800, 900, 1000, 1500, 2000, 2500, 3000, 3500, 4000, 4500, or 5000 μg/ml in liquid products or μg/g in solid products, or an amount within a range defined by any two of the aforementioned values. In some embodiments, the corresponding carrier proteins are present at an equimolar ratio.

In some embodiments, the antifungal peptidic fragments are obtained by recombinant expression, as crude extracts, or with further purification. Some embodiments provided herein relate to antifungal compositions having one or more antifungal peptidic fragments wherein one or more of said antifungal peptidic fragments are derived from plant or seed extracts or derivatives of thereof. In some embodiments, the antifungal peptidic fragments presented in Table 1 and Table 2, including any one of SEQ ID NOs: 1-166, are derived from organisms which are classified as Generally Regarded as Safe by the FDA.

In some embodiments, the recombinant organisms that produce the antifungal peptidic fragments of interest can be grown in a fermentation medium containing whole of partial extracts of Generally Regarded as Safe organisms that by themselves are sources of antimicrobial peptides (e.g. Meals of grains like quinoa, amaranth, buckwheat; peel, flesh and juice from pomegranate, onion and garlic; powder of spices such as cinnamon and cumin), thus producing a “fermented protein culture” that contains both recombinant and natural peptidic fragments. This preparation can be used, in some embodiments, as a crude extract after removal of microorganisms and other biomass, or after partial or complete purification processes.

In some embodiments, the antifungal peptidic fragments may also exhibit some antimicrobial activity, especially antifungal activity, when used alone or in combination with other “antifungal additive(s)”, such as single weak organic acids and their salts or mixes thereof, and natural extracts with antifungal properties. In this case one or more antifungal peptidic fragments along with one or more “antifungal additive(s)” will result in a synergistic effect where the overall antifungal activity of the antifungal peptidic fragment plus the “antifungal additive(s)” mixture will be greater than the activity observed for each isolated component and compared to the sum of the activity for each of the individual components.

Some embodiments provided herein relate to antifungal compositions comprising the antifungal peptidic fragment according to the present disclosure in combination to one or more “antifungal additive(s)”; where the relative amounts of the antifungal peptidic fragment of the present disclosure and the “antifungal additive(s)” being such as to produce a synergistic effect. Some embodiments provided herein relate to use of the synergistic composition in the methods of the disclosure described further herein.

Some examples of antifungal additives for foodstuff are: weak organic acids (e.g. formate, acetate, propionate and their salts), live bacterial and yeast cultures (e.g., Lactobacillus, Propionibacterium, Candida), extracts from bacteria and yeast cultures, extracts from plants (e.g., Raisin extract, Grape seed extract, Green tea extract, Origanum oil). In the case of foodstuff applications, the “antifungal additive(s)” which are particularly preferred for use in the composition, methods and uses according to the disclosure are those which are obtainable from natural sources which are classified as Generally Recognized as Safe by the FDA.

Some examples of antifungal additives for cosmetics are: weak organic acids (e.g. formate, acetate, propionate and their salts), extracts from plants (e.g.: Raisin extract, Grape seed extract, Green tea extract, Origanum oil).

Some examples of antifungal additives for paints and coatings are: arsenic disulfide, phenol, formaldehyde, quaternary ammonium compounds.

In some embodiments, the “antifungal additive(s)” are heat stable. Such stability is particularly advantageous since, for example, foodstuff and cosmetics are often subjected to very high temperatures during preparation, processing and/or packaging.

As used herein the term “antifungal composition” or “antifungal peptidic composition” has its ordinary meaning as understood in light of the specification, and is used to identify the composition based on peptidic antifungal fragments according to the present disclosure. Therefore, the antifungal composition comprises at least one of the peptidic fragments listed in the present disclosure.

The term “antifungal additive” has its ordinary meaning as understood in light of the specification, and is used herein to refer to any additive used in any industry, from natural or synthetic origin. The antifungal additive can be used in a composition combined with the antifungal agents of the present disclosure to elaborate an “anti-fungal composition”.

As used herein the term “enhance” has its ordinary meaning as understood in light of the specification, and is used to denote an improvement in antifungal activity and this may be evidenced by, for example, an observed reduction in the concentration of “antifungal additive” required to give strong fungal growth inhibition e.g. more than 90% fungal growth inhibition.

As used herein the term “synergistic” has its ordinary meaning as understood in light of the specification, and is used to denote an improvement in antifungal activity which can be demonstrated to be synergistic for example by application of the Colby Formula (Colby, 1967) or in graphical representation in isobolograms as described by Parrish and Davidson (1993).

As used herein, the term “effective amount” has its ordinary meaning as understood in light of the specification, and refers to an amount that is effective to achieve a desired result. For example, an effective amount to inhibit fungal growth includes an amount of a composition that is effective to inhibit fungal growth. A fungicidally effective amount is an amount sufficient to have fungicidal effects on a fungus. As used herein, the term “fungicidal” has its ordinary meaning as understood in light of the specification and refers to destruction of fungi, inhibition of fungal growth, or prevention of fungal growth.

The antifungal compositions of the disclosure are particularly suitable for use with a wide range of foods and beverages including bakery products, such as bread, cakes, biscuits; also fruits and vegetables, jams, fruit concentrates; and dairy products such as yogurts, cheeses, cream desserts, and milkshakes. The antifungal compositions according to the disclosure are in a form suitable for use with foodstuffs for human and animal consumption.

Other components of the antifungal composition may be chosen according to the nature of the foodstuff and to its method of consumption and this will be readily apparent to anyone skilled in the art.

The antifungal peptidic agents can be applied to avoid the spoilage of cosmetics, such as creams and makeup. The antifungal peptidic agents can also be applied to paint and other liquid coatings for avoiding fungal growth in surfaces.

The other components of the antifungal composition can be also selected among the appropriate or acceptable additives for the corresponding application, such as cosmetics and paintings or coatings additives.

The product or environment in which it is desired to inhibit fungal growth may be exposed to the antifungal composition or the formulation comprising the antifungal composition in a variety of ways which will most usually be determined by the nature of the product to be protected. The product and the formulation or composition of the disclosure may, for example, be mixed together during the manufacturing process. Alternatively or additionally, the container in which the product is packaged may be sprayed with the composition before the product is added and/or sprayed with the composition after packing and/or filling. This form of application is particularly useful for food and cosmetic products. The composition of the disclosure may also be used in conjunction with painting or coating products, for example, using the antifungal agent of the disclosure when elaborating the master batch, or by admixing the antifungal composition of the disclosure in the final coating product. Alternatively, a protective coat formulation can be applied by mixing the antifungal composition in the second layer of paintings and coatings for surfaces, such as hospital buildings and rooms.

### EXAMPLES

Some aspects of the embodiments discussed above are disclosed in further detail in the following examples, which are not in any way intended to limit the scope of the present disclosure. Those in the art will appreciate that many other embodiments also fall within the scope of the disclosure, as it is described herein above and in the claims.

### Example 1: Inhibition of Fungal Growth In Vitro with Antifungal Peptide Having a Sequence as Set Forth in SEQ ID NO: 1

The following example demonstrates an example method for inhibiting fungal growth using a composition having a peptide with an amino acid sequence as set forth in SEQ ID NO: 1.

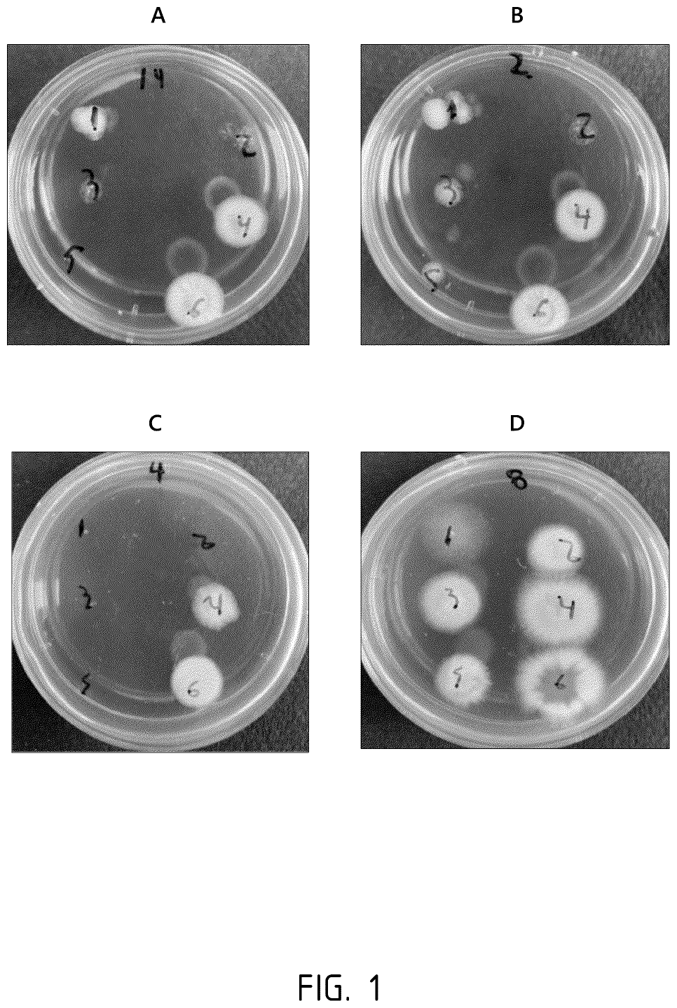

Antifungal peptide having an amino acid sequence as set forth in SEQ ID NO: 1 (Table 1) was genetically fused to 6 amino-terminal histidine residues, expressed and produced in a recombinant manner in Escherichia coli, and after cell lysis, peptide purified using immobilized metal affinity chromatography (IMAC) with nickel resin. A second variant of antifungal peptide having an amino acid sequence as set forth in SEQ ID NO: 1 was also generated, fusing the antifungal peptide to a carrier protein. Dialysis was performed to exchange buffers and remove unwanted salts from the purification process. Fungal inhibition was then assessed in agar plates containing embedded antifungal peptides, incubating 2 days at 30° C. Fungal strains Trichoderma reesei, Fusarium oxysporum, Rhizopus oligosporum, Aspergillus niger and two environmental isolates were tested (FIG. 1). As shown in the figure, different variations of the peptide SEQ ID NO: 1 were tested. FIG. 1 Panel A contains 150 μg/ml of peptidic antifungal without carrier protein, FIG. 1 Panel B contains 150 μg/ml of peptidic antifungal composition without carrier protein pre-treated for 10 minutes at 90° C. FIG. 1 Panel C contains 175 μg/ml of peptidic antifungal composition fused to a carrier protein. Finally, FIG. 1 Panel D represents the negative control without peptidic antifungal composition. As shown in the FIG. 1A, the antifungal peptide SEQ ID NO: 1 impacts the growth of all fungi when compared with the control condition, although to a lesser extent with the environmental fungal isolates. Pre-incubation of peptide formulation at 90° C. does not impair its activity (FIG. 1 Panel B), suggesting that this formulation has thermostable properties. Finally, fusion of the antifungal peptide SEQ ID NO: 1 to a carrier protein improves the activity against all tested fungi. These results highlight the antifungal activity and broad spectrum of the generated formulations, and show that they possess activity when fused to terminal repeated charged (histidine) amino acids or when fused to a solubility carrier protein.

Similarly, any one of the remaining sequences as set forth in Table 1, including any one or more of SEQ ID NOs: 2-166 are used in a similar manner as described herein with respect to SEQ ID NO: 1.

### Example 2: Inhibition of Fungal Growth In Vitro with Antifungal Peptides Having Sequences as Set Forth in SEQ ID NOs: 1, 28, and 29 Fused to Different Solubility Proteins

The following example demonstrates an example method for inhibiting fungal growth using a composition having a peptide with an amino acid sequence as set forth in SEQ ID NO: 1, SEQ ID NO: 28, or SEQ ID NO: 29.

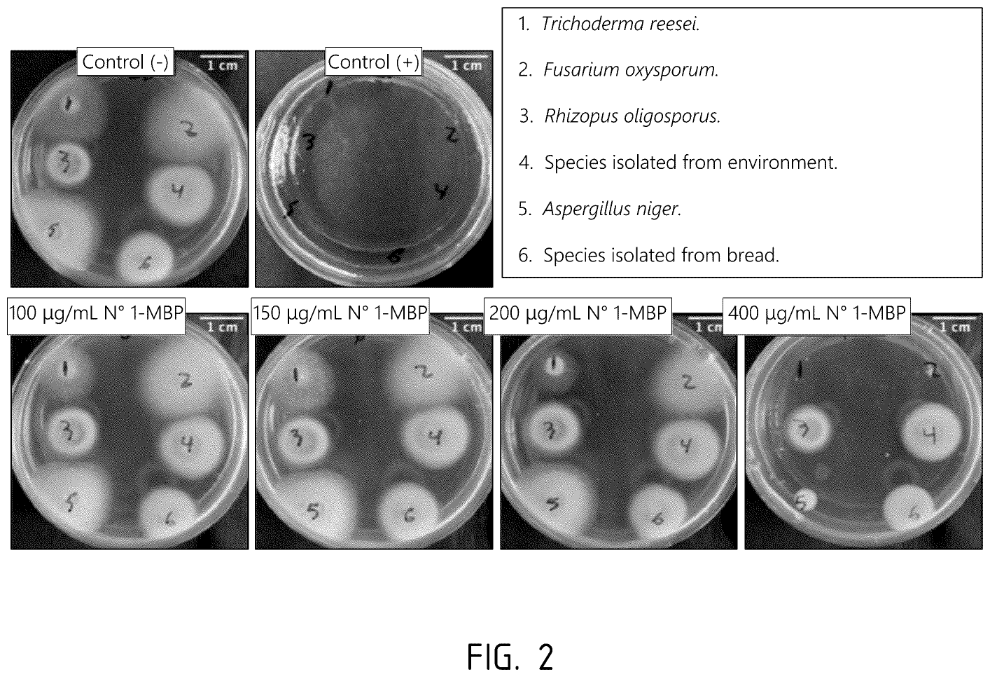

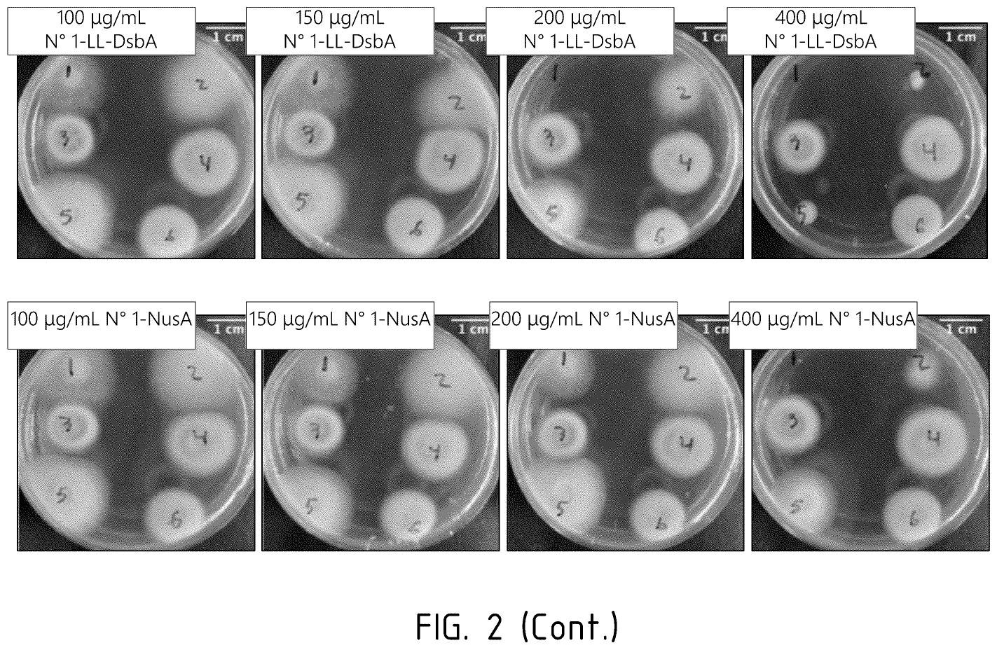

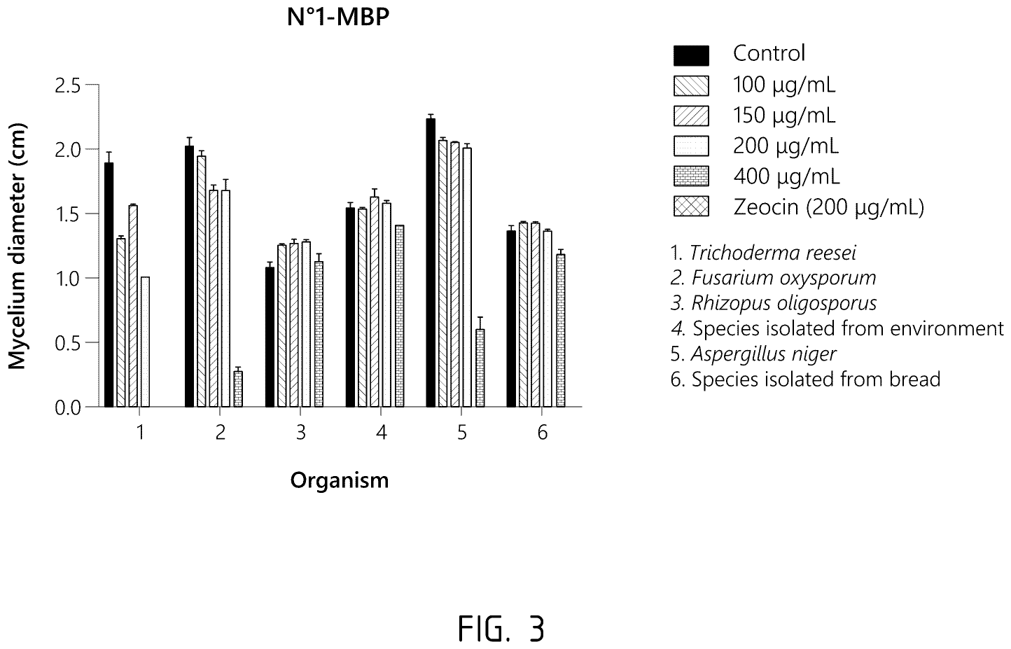

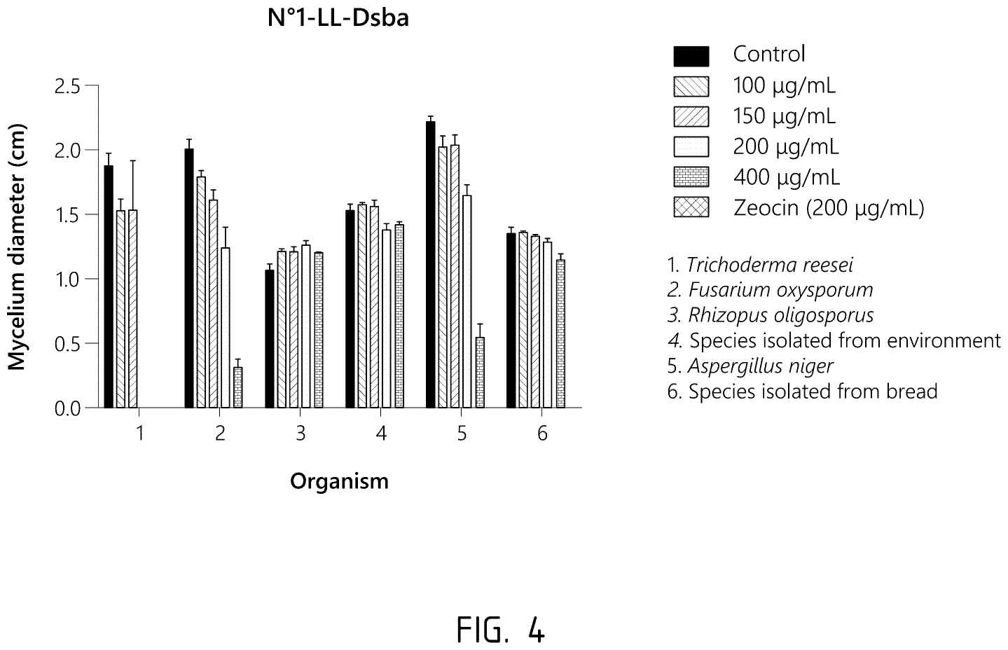

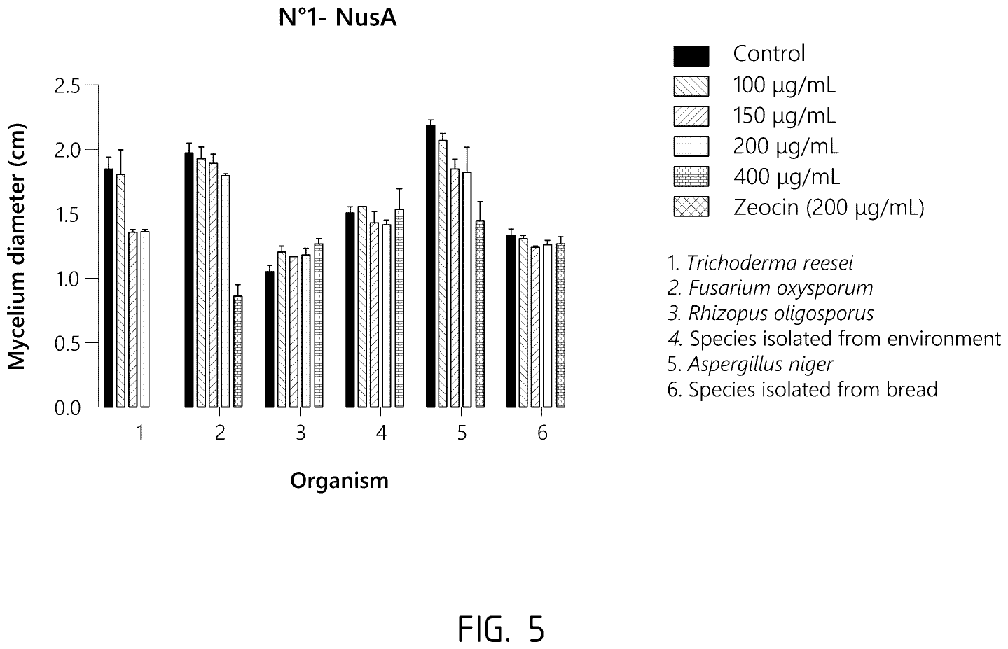

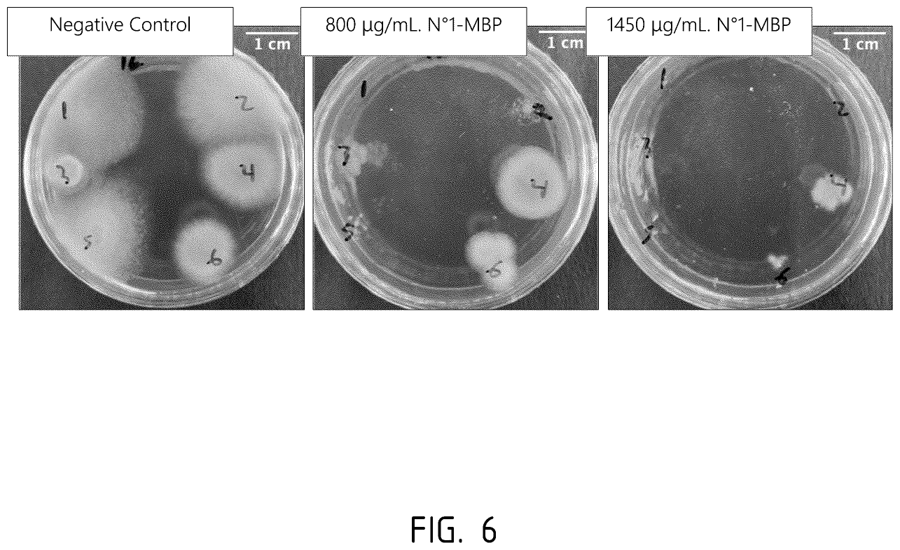

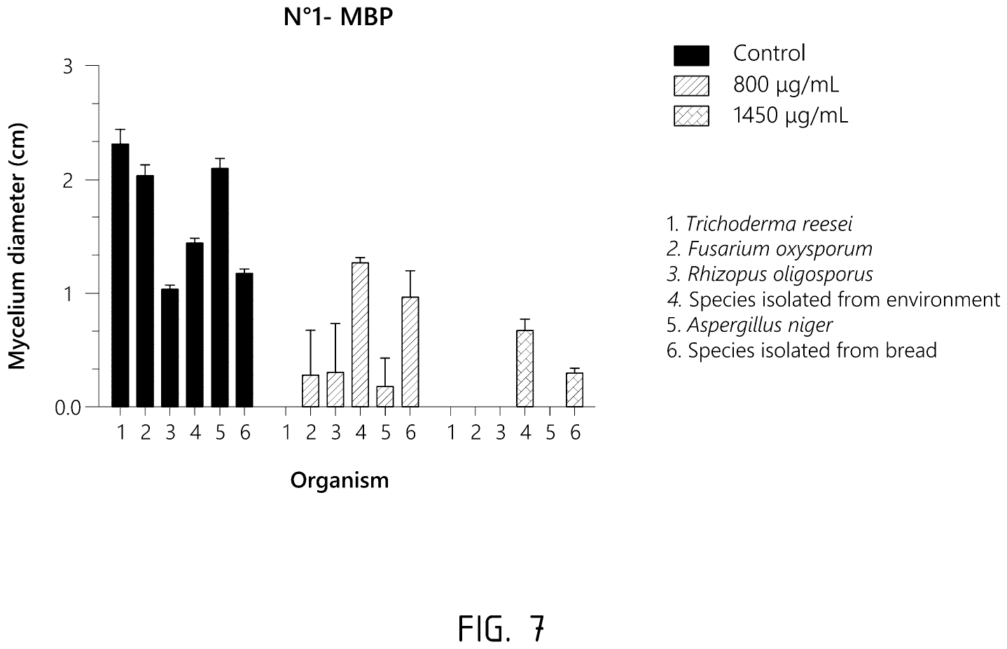

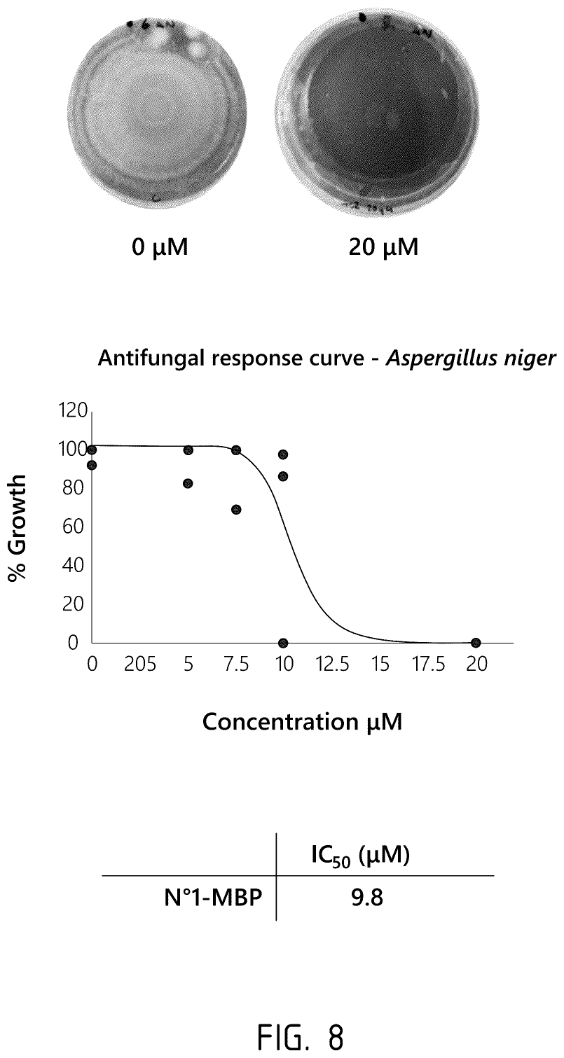

To further test the versatility of antifungal peptides, these were genetically fused to a variety of different carrier solubility proteins, and their antifungal activity tested. Purification was carried out as described in Example 1. First, antifungal peptide SEQ ID NO: 1 was fused to MBP, LL-DsbA, or NusA solubility proteins. After purification, all three variants were tested by embedding in plate assays at low concentrations against six target fungi (FIG. 2). Mycelium length was then estimated and analyzed (FIGS. 3, 4, and 5). These results showed that all variants showed clear inhibition activity at 400 μg/ml, and with T. reesei, F. oxysporum, and A. niger species showing the highest sensitivity, while the environmental fungals isolates showed a higher resistance to the antifungal agent. When comparing the different SEQ ID NO: 1-solubility protein fusions, SEQ ID NO: 1-MBP performed the best, showing the biggest reduction in mycelium diameter on tested strains. SEQ ID NO: 1-MBP was investigated further at higher concentrations in antifungal assays (FIGS. 6 and 7), which revealed that at concentrations of 800 μg/ml and above this formulation could also clearly inhibit the growth of the environmental fungal isolates. Finally, the effect of SEQ ID NO: 1-MBP antifungal peptide-protein fusion on A. niger was examined in detail (FIG. 8). Three independent experiments were performed that showed that the IC50=9.8 μM (450 μg/mL) for this peptide and strain.

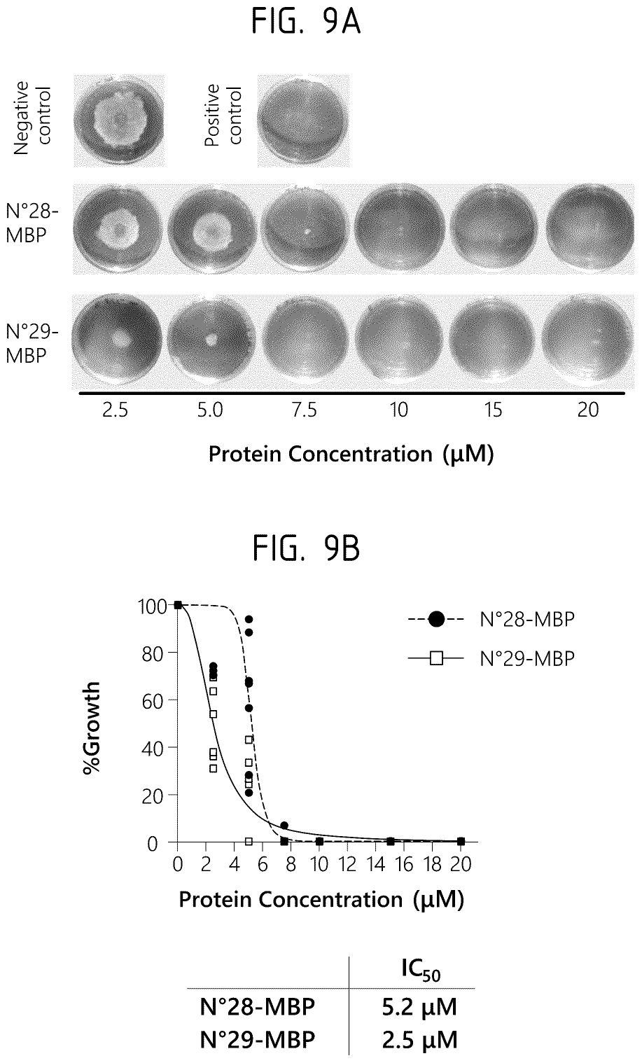

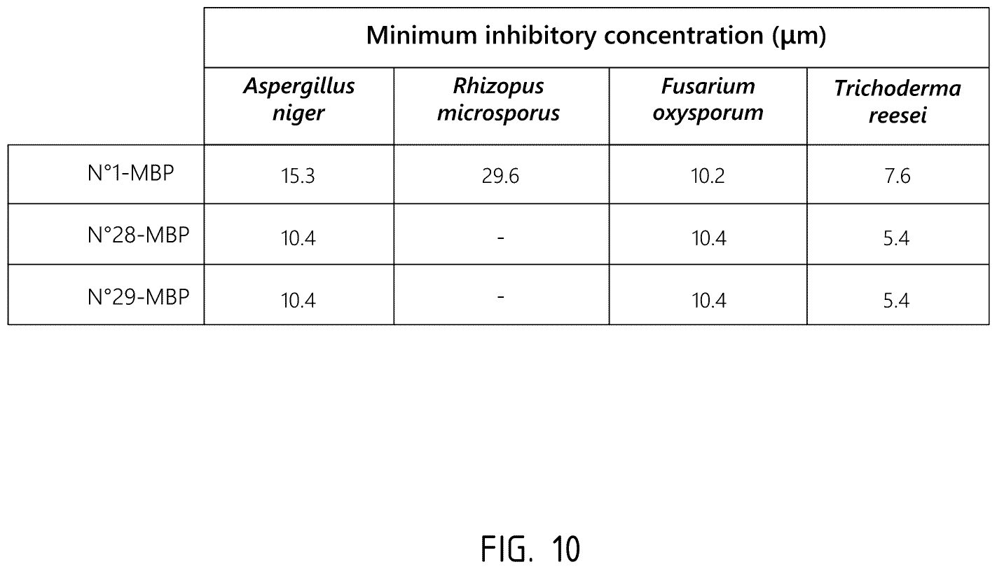

To further validate the antifungal peptide sequences two further peptides, SEQ ID NO: 28 and SEQ ID NO: 29, were examined. These were genetically fused to the MBP solubility protein gene, and expressed in E. coli as explained above. When analyzed for their antifungal activity against A. niger (FIGS. 9A and 9B), plate assays with embedded antifungals showed that both inhibited growth, and showed IC50=5.2 for SEQ ID NO: 28-MBP and IC50=2.5 for SEQ ID NO: 29-MBP. Finally, all three antifungals were tested in liquid based minimum inhibitory concentration (MIC) assays (FIG. 10) which showed that all three peptides possessed similar MIC values, with slightly lower MIC for SEQ ID NO: 28-MBP and SEQ ID NO: 29-MBP against A. niger and T. reesei.

These results show that peptides SEQ ID NO: 1, SEQ ID NO: 28, and SEQ ID NO: 29 are active antifungals, and when fused to a carrier solubility protein can be purified and used to inhibit growth of varied fungal species. While all three peptides required similar amounts to completely inhibit growth of fungal species (reflected in the MIC), peptide SEQ ID NO: 29 showed the highest potency at sub-MIC concentrations (reflected in the IC50).

Similarly, any one of the remaining sequences as set forth in Table 1, including any one or more of SEQ ID NOs: 2-27 or 30-166 are used in a similar manner as described herein with respect to SEQ ID NOs: 1, 28, and 29.

### Example 3: Inhibition of Fungal Growth in Bread by Addition of Antifungal Peptides Having Sequences as Set Forth in SEQ ID NOs: 1, 28, and 29

The following example demonstrates an example method for inhibiting fungal growth in bread using a composition having a peptide with an amino acid sequence as set forth in SEQ ID NO: 1, SEQ ID NO: 28, or SEQ ID NO: 29.

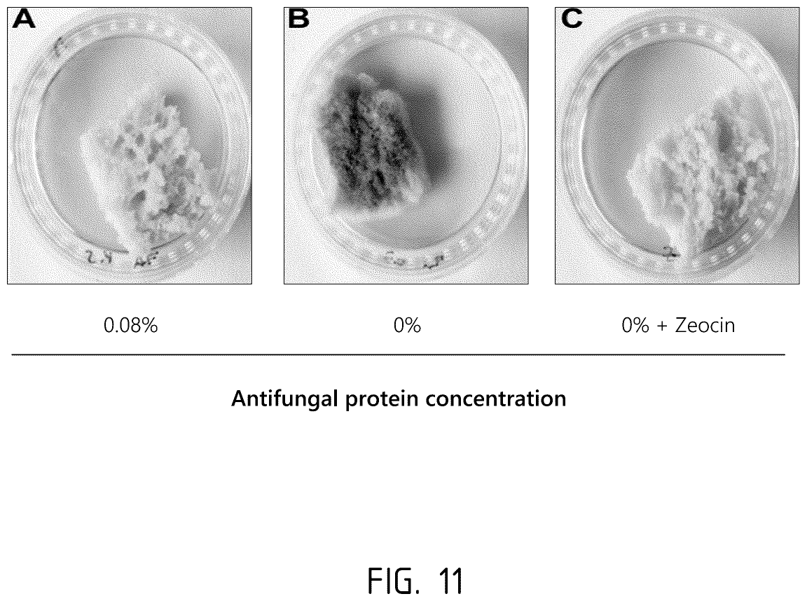

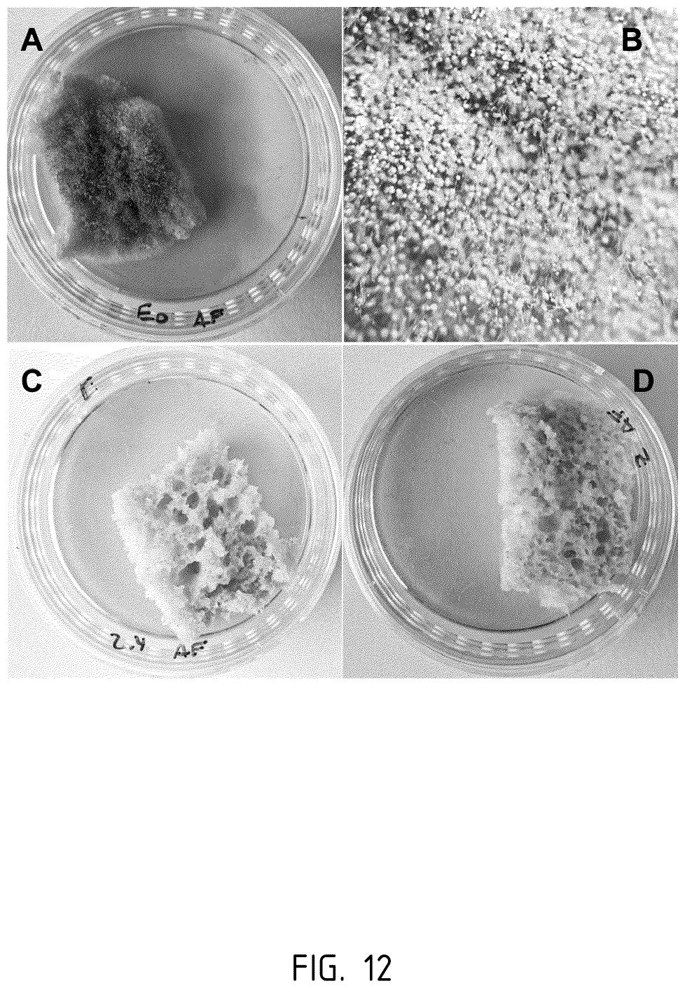

To validate the functionality of antifungals in a complex matrix, the activity of antifungal proteins in bread was tested. The antifungal peptides were added to bread fragments post-baking, and the ability to control growth of inoculated spores was evaluated. As observed in FIG. 11, SEQ ID NO: 29-MBP peptide-protein fusion inhibited the growth of Aspergillus flavus at 0.08% w/w use in bread after 14 days of incubation. The experiment was repeated with a lower does (0.06% w/w) and similar results were observed (FIG. 12). This effect persists until the 20 day period, when fungal growth is also apparent in treated bread.

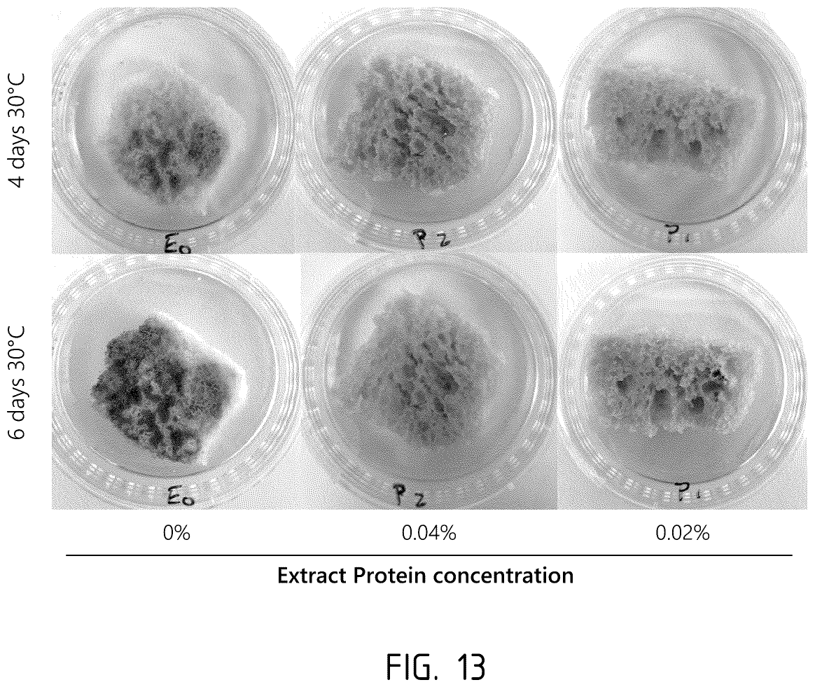

The ability of SEQ ID NO: 29 antifungal peptide to be active as part of a non-purified multiprotein formulation was tested. To this end, SEQ ID NO: 29-MBP was produced in Pichia pastoris yeast by fermentation, and recovered from culture supernatants. Once a concentrated protein fraction of the supernatant was obtained, an antifungal assay was carried out on bread. For this, two concentrations of total protein, 0.04% and 0.02% w/w, were added to the bread inoculated with A. niger. Then, it was incubated for 6 days at 30° C., at which time the growth of the fungus was evaluated (FIGS. 12 and 13). As observed, there is a significant inhibition of the growth of the fungus in the presence of the antifungal protein extract.

Similarly, any one of the remaining sequences as set forth in Table 1, including any one or more of SEQ ID NOs: 2-27 or 30-166 are used in a similar manner as described herein with respect to SEQ ID NOs: 1, 28, and 29.

### Example 4: Molecular Dynamics of Antifungal Peptide Binding to Chitin Surfaces

The following example demonstrates an example for determining the molecular dynamics of the antifungal peptides as set forth herein for binding to chitin surfaces.

To explore the molecular interactions of the tested antifungal peptides, including the peptides having sequences as set forth in SEQ ID NOs: 1, 28, and 29, and fusions thereof (such as SEQ ID NO: 1-MBP, SEQ ID NO: 28-MBP, or SEQ ID NO: 29-MBP), unbiased molecular dynamic (MD) simulations of a single free peptide near a chitin surface (F) were performed. Two replicate simulations were run for 1 us each for each peptide variant. MM/PBSA calculations were used to evaluate both the potential for spontaneous binding of the peptides to the chitin surface as well as the strength of the peptide-chitin interaction.

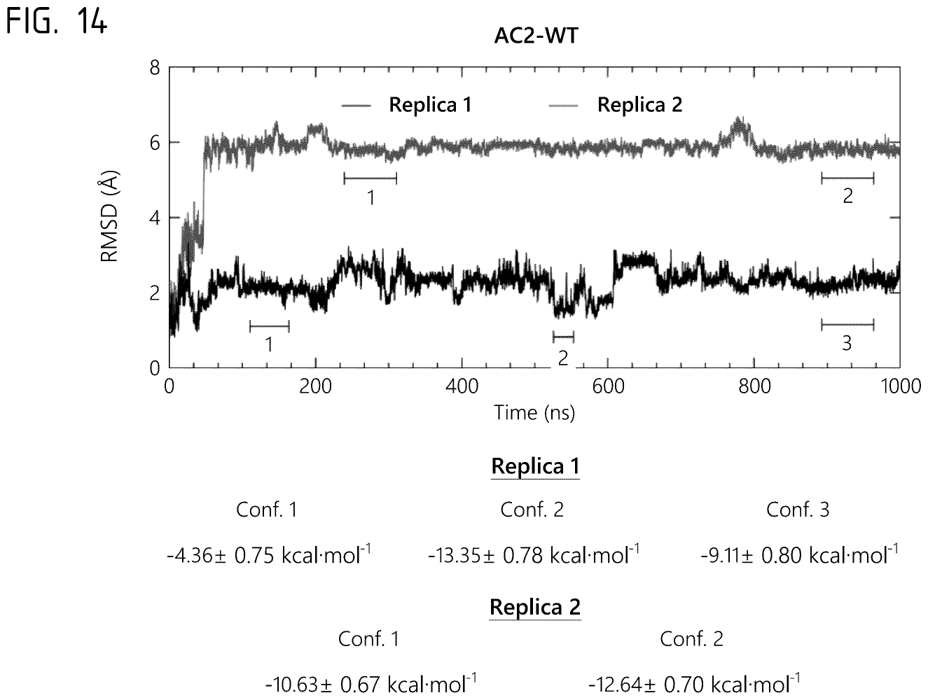

These simulations were evaluated for SEQ ID NO: 1-MBP antimicrobial peptide. RMSD time-series data showed important deviations between the simulated SEQ ID NO: 1-MBP structure and its crystal structure (FIG. 14). The highest RMSD values that replica 1 achieved were approximately ˜3.0 Å, whereas replica 2 achieved values near ˜6 Å, when the peptide was compared with its crystal structure (FIG. 14). Both simulations achieved a roughly stable RMSD after the first 50 ns. Interestingly, despite the high RMSD for replica 2, the predicted relative binding energy for replica 2 was either higher (−10.63 to −12.64 kcal·mol⁻¹) than some of the selected structural configurations from replica 1 (−4.36 and −9.11 kcal·mol⁻¹ for configurations 1 and 3 in replica 1, respectively) or within the same order of magnitude (−13.35 kcal·mol⁻¹ for configuration 2 in replica 1) (FIG. 14).

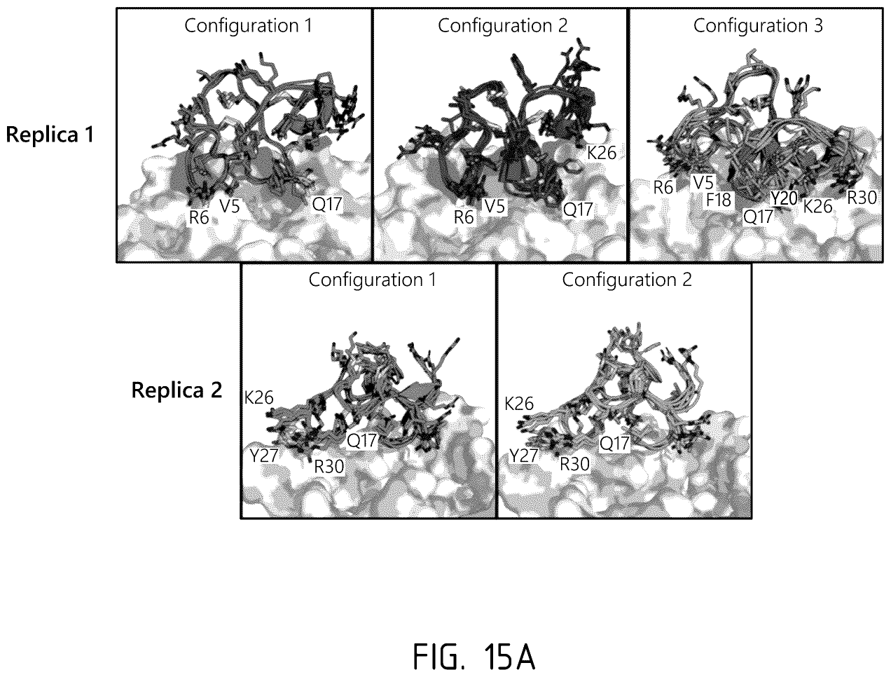

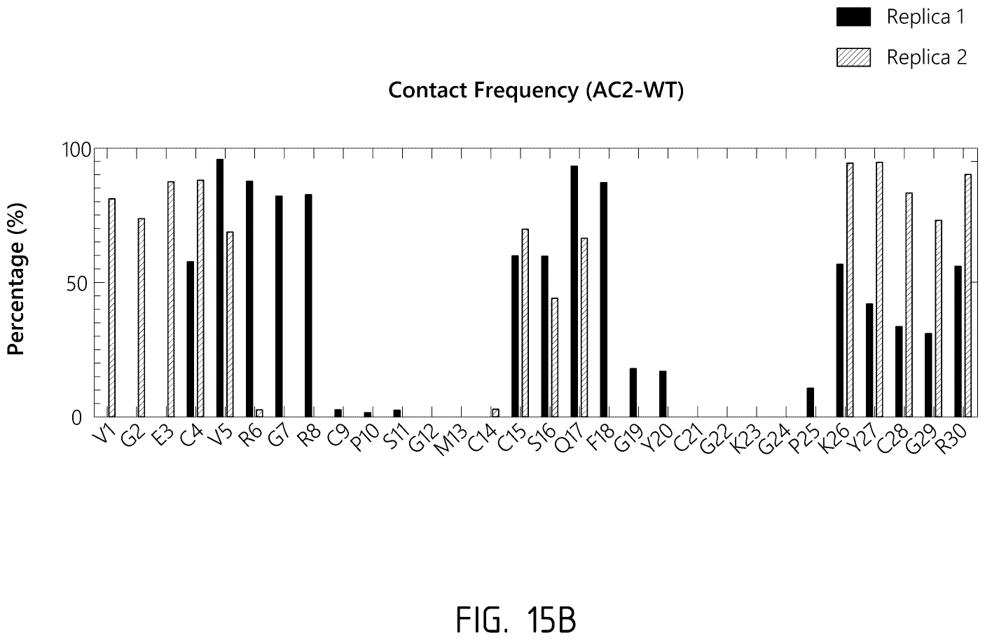

The selected SEQ ID NO: 1-MBP protein configurations with residues that were in contact with the chitin surface are depicted in FIGS. 15A-15B. In replica 1, the number of interactions increased over time, with more residues seen close to the chitin surface (FIG. 15A). However, more peptide-chitin contacts did not translate to higher interaction energy, since the interaction energy changed from −13.35 to −9.11 kcal·mol⁻¹ between configurations 2 and 3 (FIG. 14 and FIG. 15A). In replica 2, most of the peptide-chitin contacts stabilized earlier in the simulations, with no important visual differences (FIG. 15A). Despite the differences among replicas and configurations, there was an observable pattern in the regions in contact with the chitin surface (FIG. 15B), with the beginning, middle, and end of the protein structure involved in most of the contacts. The only difference between replicas was that the initial region of SEQ ID NO: 1-MBP peptide stayed in contact with the chitin surface in replica 2 but not in replica 1 (FIG. 15B). It is also important to note that SEQ ID NO: 1-MBP interacted with the chitin surface through aromatic residues F18, Y20, and Y27.

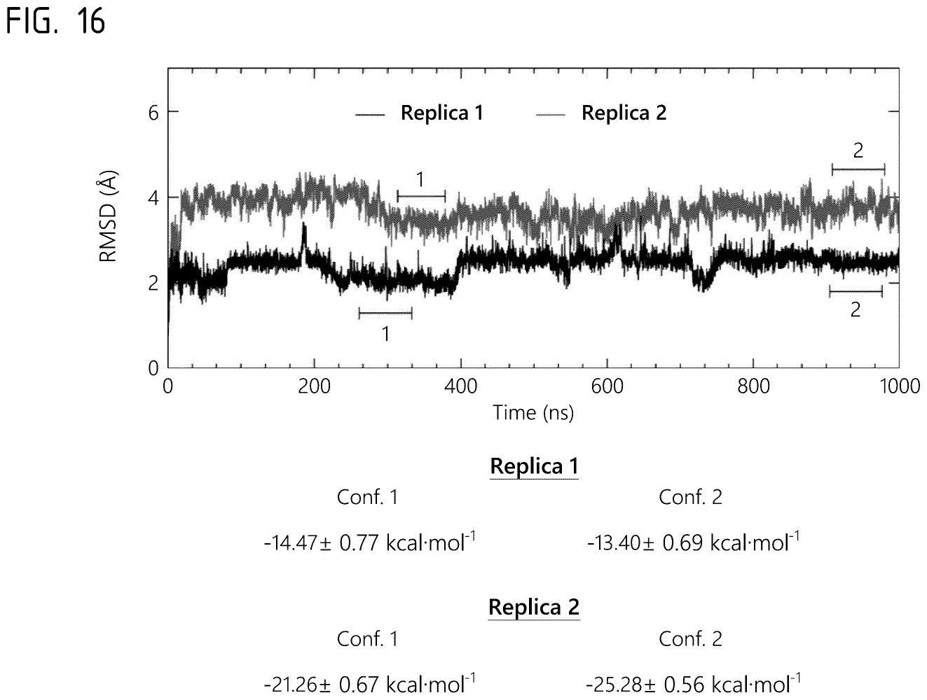

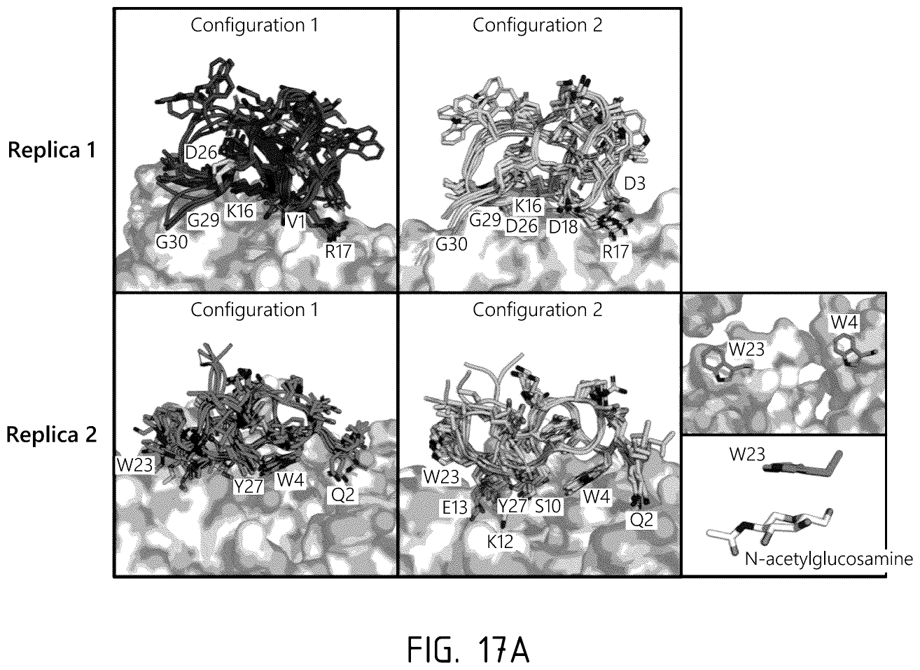

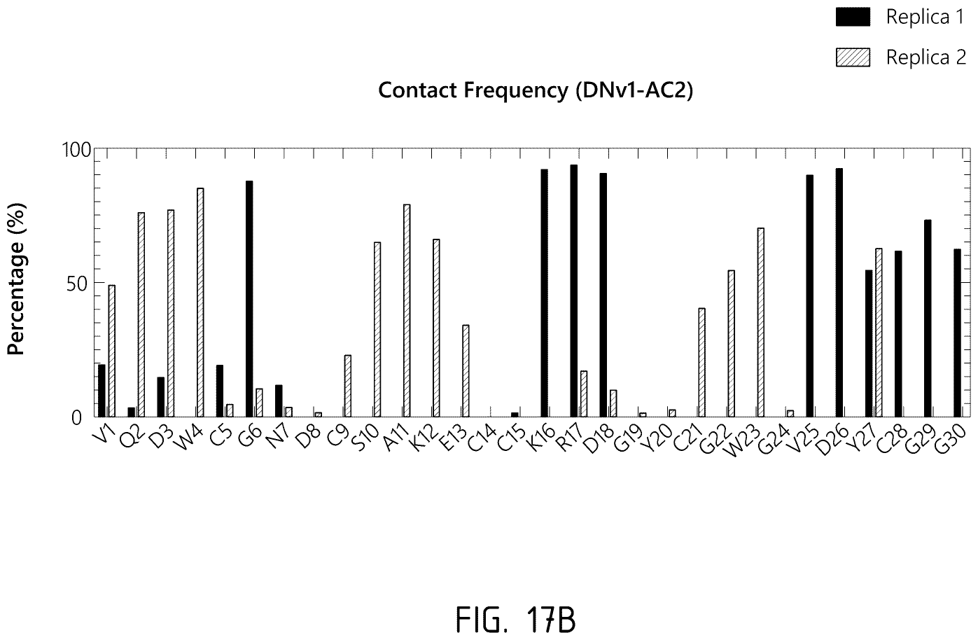

Similar analyses were performed for the AI-generated peptide variant SEQ ID NO: 28-MBP. RMSD time-series data showed that the peptide conformation remained close to the initial conformation in both replicas, with average RMSD values of 2.42 and 3.68 Å for replicas 1 and 2, respectively (FIG. 16). These roughly stable conformations were achieved early, after approximately 30 ns of the simulation, which was similar to the SEQ ID NO: 1-MBP simulations (FIG. 16). In terms of binding free energies, the two selected configurations from replica 1 achieved energies of the same magnitude as SEQ ID NO: 1-MBP, with values of −14.47 kcal·mol⁻¹ and −13.40 kcal·mol⁻¹ (FIG. 16). The contact regions in replica 1 of the SEQ ID NO: 28-MBP variant are similar as well, with the main contacts located in the middle and end portions of the structure (FIGS. 17A and 7B) and some contacts locating at the beginning, especially at residue G6, which was in contact with the chitin surface for 83% of the simulation (FIG. 17B).

Interestingly, replica 2 behaved differently from replica 1. The relative binding energies were higher for both selected configurations from replica 2, with values of −21.26 kcal·mol⁻¹ and −25.28 kcal· mol⁻¹ (FIG. 16). The contact area was different from replica 1 as well, with most contacts at the beginning (from residue 1 to 7) and middle (from residue 9 to 13) of the structure (FIGS. 17A and 7B). New contacts were also established in the region between residues 21 and 23 (FIGS. 17A and 7B). One possible explanation for the higher energies of this configuration is the interactions of residue W4 and W23, as shown in FIG. 7A (bottom right panels). It has previously been shown that these types of interactions, where tryptophan residues are flatly aligned in a CH-r orientation, occur between chitinases and chitin. These interactions are also frequently observed between proteins and sugars.

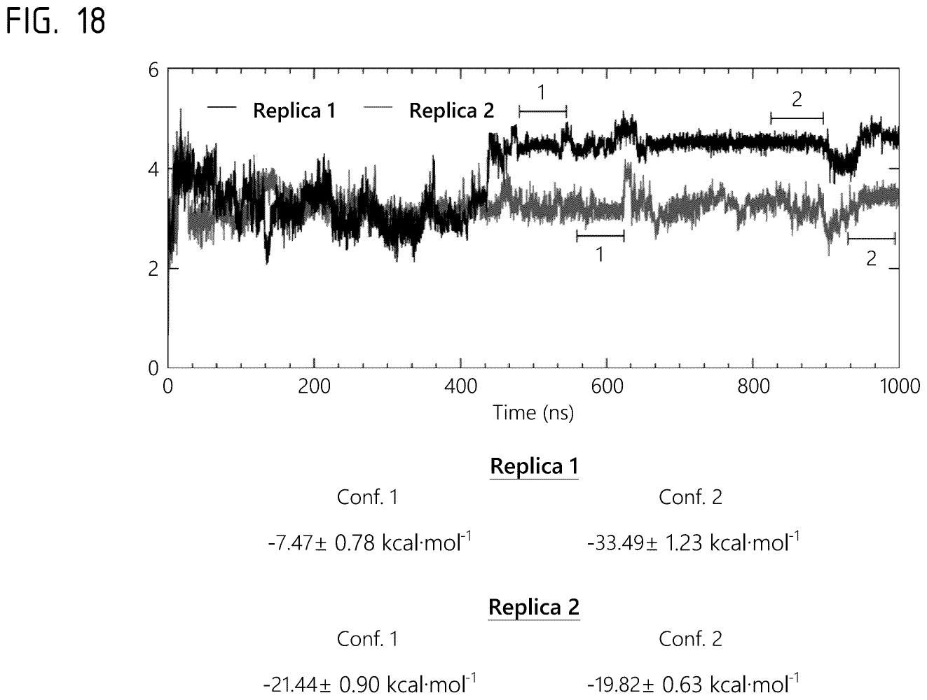

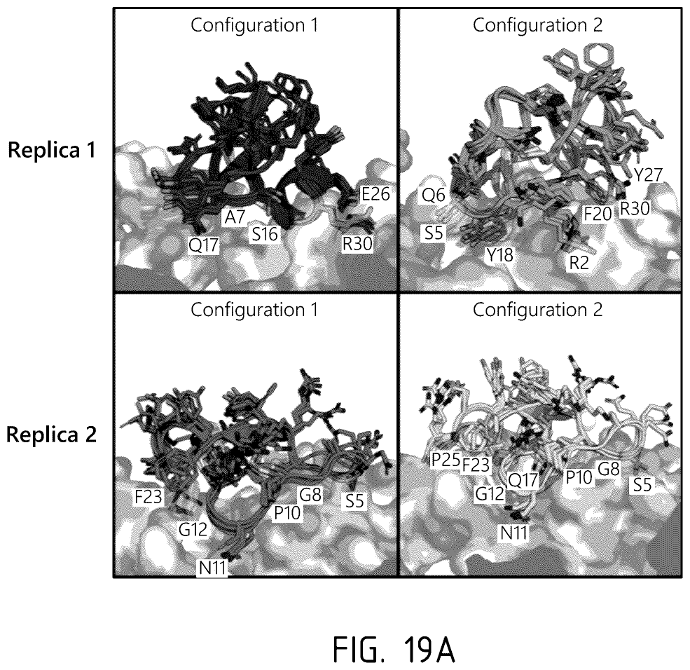

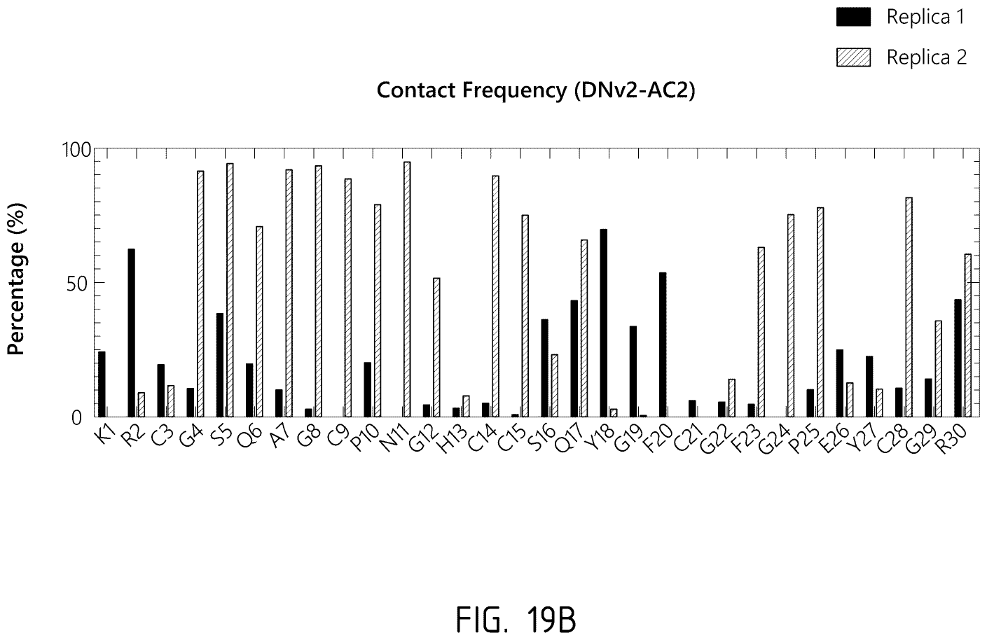

RMSD time-series data for the SEQ ID NO: 29-MBP variant showed similar results to the SEQ ID NO: 28-MBP variant, with values of 3.94 Å and 3.24 Å for replica 1 and 2, respectively (FIG. 18). Two conformations were selected from each replica, spanning the simulation times shown in FIG. 18, and MM/PBSA calculations were performed for each conformation. As shown in FIG. 18, the relative binding energies were dependent on the peptide configuration. For replica 1, the first selected conformation only exhibited an average energy of −7.47 kcal·mol⁻¹ (FIG. 18), whereas the binding energy increased to −33.49 kcal·mol⁻¹ by the second configuration. The main difference between these two configurations is the presence of aromatic residues, such as residues Y18, F20 and Y27, in direct contact with the chitin surface in configuration 2. These residues are similar to the SEQ ID NO: 1-MBP peptide (FIG. 19A).

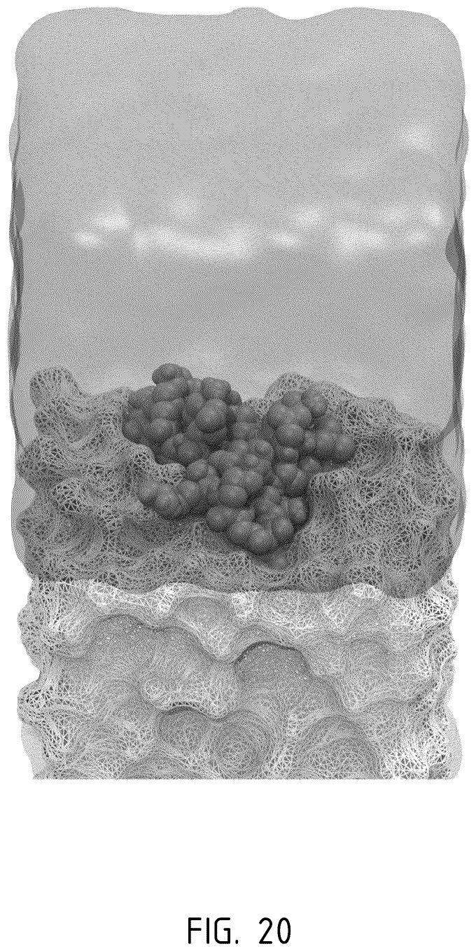

In replica 2, the peptide-chitin interactions occurred mostly at the hydrophobic residues G4, A7, G8, G12, G24, and G29. Residue F23 was the only aromatic residue in direct contact with the chitin surface (FIG. 19A). These differences may explain the strength of the interaction compared to the second configuration from replica 1 (FIG. 18). However, this peptide-chitin interaction is still stronger than SEQ ID NO: 1-MBP and is similar to the SEQ ID NO: 28-MBP variant, potentially due to residues Q6, Q17, and R30, which can help in the formation of salt bridges and hydrogen bond interactions (FIG. 19B). It is important to note that arginine residues, which were present in all the tested variants and were also seen directly interacting with the chitin surface (FIGS. 15, 17, and 19A-19B), allow the peptides to interact with anionic components. A graphical representation of the molecular interactions of the antifungal peptides with the chitin surface in an aqueous environment can be seen in FIG. 20.

Similarly, any one of the remaining sequences as set forth in Table 1, including any one or more of SEQ ID NOs: 2-27 or 30-166 are used in a similar manner as described herein with respect to SEQ ID NOs: 1, 28, and 29.

With respect to the use of plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those of skill within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

Any of the features of an embodiment of the first through second aspects is applicable to all aspects and embodiments identified herein. Moreover, any of the features of an embodiment of the first through third aspects is independently combinable, partly or wholly with other embodiments described herein in any way, e.g., one, two, or three or more embodiments may be combinable in whole or in part. Further, any of the features of an embodiment of the first through third aspects may be made optional to other aspects or embodiments.

### REFERENCES

Abdel-Rahim, I. R., Nafady, N. A., Bagy, M. M., Abd-Alla, M. H., & Abd-Alkader, A. M. (2019). Fungi-induced paint deterioration and air contamination in the Assiut University hospital, Egypt. Indoor and Built Environment. 28(3), 384-400.
Colby, S. R. (1967). Calculating synergistic and antagonistic responses of herbicide combinations. Weeds, 15(1), 20-22.
Cottier, F., Tan, A. S. M., Chen, J., Lum, J., Zolezzi, F., Poidinger, M., & Pavelka, N. (2015). The transcriptional stress response of Candida albicans to weak organic acids. G3: genes, genomes, genetics, 5(4), 497-505.
Lundov, M. D., Moesby, L., Zachariae, C., & Johansen, J. D. (2009). Contamination versus preservation of cosmetics: a review on legislation, usage, infections, and contact allergy. Contact Dermatitis, 60(2), 70-78.
Parjo, U. K., Sunar, N. M., Leman, A. M., Er. C. M., & Gani, P. (2015). Effect of fungal growth on the surface of painted plasterboards. Advances in Environmental Biology, 9(20 S1), 15-20.
Parrish and Davidson (1993) (In: Antimicrobials in foods. Ed. By P. M. Davidson and A. L. Branen. Marcel Dekker, Inc. New York).
Rogozhin, E. A., Sadykova, V. S., Baranova, A. A., Vasilchenko, A. S., Lushpa, V. A., Mineev, K. S., . . . & Vasilchenko, A. V. (2018). A novel lipopeptaibol emericellipsin A with antimicrobial and antitumor activity produced by the extremophilic fungus Emericellopsis alkalina. Molecules, 23(11), 2785.
Slavokhotova, A. A., Shelenkov, A. A., Andreev, Y. A., & Odintsova, T. I. (2017). Hevein-like antimicrobial peptides of plants. Biochemistry (Moscow), 82(13), 1659-1674.
Snyder, A. B., & Worobo, R. W. (2018). Fungal spoilage in food processing. Journal of food protection, 81(6), 1035-1040.

What is claimed is:

1. A food preservative, comprising:
an antifungal agent present in a fungicidally effective amount, the antifungal agent comprising one or more antifungal peptidic fragments having an amino acid sequence as set forth in any one of SEQ ID NOs: 1-166; and
one or more antifungal additives or one or more antifungal components.

2. The food preservative of claim 1, wherein the one or more antifungal additives comprise one or more natural compositions or one or more synthetic compositions.

3. The food preservative of claim 1, wherein the one or more antifungal additives is a weak organic acid, a bacterial culture, a bacterial extract, a yeast culture, a yeast extract, or a plant extract.

4. The food preservative of claim 1, wherein the one or more antifungal additives is plant-derived.

5. The food preservative of claim 1, wherein the food preservative is formulated for combination with a foodstuff.

6. The food preservative of claim 1, wherein the food preservative is formulated in a foodstuff packaging.

7. The food preservative of claim 1, wherein the fungicidally effective amount is in an amount of at least 0.06% w/w.

8. The food preservative of claim 1, further comprising one or more carrier fusion proteins comprising the one or more antifungal peptidic fragments and a carrier protein,
wherein the one or more carrier fusion protein is adapted to enhance solubility, protein folding, or production yield of the food preservative.

9. The food preservative of claim 1, wherein the antifungal agent is suitable for use in a bakery product, fruit product, vegetable product, or dairy product.

10. The food preservative of claim 1, wherein the antifungal agent is suitable for use with foodstuff for human consumption or animal consumption.

11. The food preservative of claim 1, wherein the antifungal agent retains functionality when combined with a foodstuff during or after manufacture of the foodstuff.

12. The food preservative of claim 11, wherein the foodstuff is a solid foodstuff or a liquid foodstuff.

13. The food preservative of claim 11, wherein the foodstuff is manufactured at a temperature of up to 90° C.

14. The food preservative of claim 11, wherein the antifungal agent is present in an amount ranging from about 5 μg/g to about 5,000 μg/g.

15. The food preservative of claim 1, wherein the one or more antifungal peptidic fragments have greater than 80% sequence similarity to an amino acid sequence as set forth in any one of SEQ ID NOs: 1-166.

16. A method of preserving a food product, comprising:
providing a foodstuff; and
combining the foodstuff with a fungicidally effective amount of an antifungal agent,
wherein the antifungal agent is comprised of one or more antifungal peptidic fragments having an amino acid sequence as set forth in any one of SEQ ID NOs: 1-166; and
combining the foodstuff with one or more antifungal additives or components.

17. The method of claim 16, wherein the one or more antifungal additives comprise one or more natural compositions or one or more synthetic compositions.

18. The method of claim 16, wherein the foodstuff and the antifungal agent are combined and then processed at a temperature of up to 90° C.

19. The method of claim 16, wherein the antifungal agent is fused with a carrier protein.

20. The method of claim 19, wherein the carrier protein is a maltose binding protein (MBP), a glutathione S-transferase, a thioredoxin, a transcription elongation factor NusA (NusA), a thiol disulfide oxidoreductases (DsbA), or a small ubiquitin-like modifier.

21. The method of claim 20, wherein the carrier protein enhances solubility, protein folding, or production yield of the antifungal agent.

22. The method of claim 16, wherein the fungicidally effective amount is at least 0.06% w/w.

23. The method of claim 16, wherein the antifungal agent is suitable for use in bakery products, fruit products, vegetable products, and/or dairy products.

24. The method of claim 16, wherein the antifungal agent is suitable for use with foodstuff for human consumption and/or animal consumption.

25. The method of claim 16, wherein the antifungal agent retains functionality when combined with the foodstuff during or after manufacture of the food product.

26. The method of claim 16, wherein the foodstuff is a solid or a liquid.

27. The method of claim 26, wherein the antifungal agent is present in an amount ranging from about 5 μg/g to about 5,000 μg/g.

28. The method of claim 16, wherein the one or more antifungal peptidic fragments show greater than 80% sequence similarity to an amino acid sequence as set forth in any one of SEQ ID NOs: 1-166.
